(19) United States
(12) Patent Application Publication
(10) Pub. No.: US 2026/0150083 A1
(43) Pub. Date: May 28, 2026

(54) ANCHOR-ASSISTED TRACKING OF MOVING TARGET

(71) Applicant: QUALCOMM Incorporated, San Diego, CA (US)

(72) Inventor: Feliciano GOMEZ MARTINEZ, Los Gatos, CA (US)

(21) Appl. No.: 18/962,693

(22) Filed: Nov. 27, 2024

(51) Int. Cl. H04W 64/00; H04B 17/318

(52) U.S. Cl. CPC H04W 64/006; H04B 17/328

(57) ABSTRACT

Aspects presented herein may enable a first UE to locate a second UE via an anchor device when they are not within a direct communication with each other, and also when they are moving. In one aspect, a first UE communicates, with a second UE, an anchor device to be used for tracking a position of the second UE. The first UE obtains a first set of measurements based on a reference frame of the first UE. The first UE receives, from the second UE, a second set of measurements based on a reference frame of the second UE. The first UE estimates the position of the second UE based on the first set of measurements and the second set of measurements.

### TECHNICAL FIELD

The present disclosure relates generally to communication systems, and more particularly, to wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning (e.g., including tracking and/or ranging) protocols and techniques that enable mobile network operators to provide high-accuracy location/tracking/ranging services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus communicates, with a second user equipment (UE), an anchor device to be used for tracking a position of the second UE. The apparatus obtains, based on a first reference frame of the first UE, (1) a first set of coordinates of the anchor device with respect to the first reference frame, (2) a second set of coordinates of a gravity vector with respect to the first reference frame, (3) a third set of coordinates of a magnetic north vector with respect to the first reference frame, and (4) a first set of displacements of the first UE. The apparatus receives, from the second UE, (1) a fourth set of coordinates of the anchor device with respect to a second reference frame of the second UE, (2) a fifth set of coordinates of the gravity vector with respect to the second reference frame, (3) a sixth set of coordinates of the magnetic north vector with respect to the second reference frame, and (4) a second set of displacements of the second UE. The apparatus estimates the position of the second UE based on (1) the first set of coordinates of the anchor device with respect to the first reference frame, (2) the second set of coordinates of the gravity vector with respect to the first reference frame, (3) the third set of coordinates of the magnetic north vector with respect to the first reference frame, (4) the first set of displacements of the first UE, (5) the fourth set of coordinates of the anchor device with respect to the second reference frame, (6) the fifth set of coordinates of the gravity vector with respect to the second reference frame, (7) the sixth set of coordinates of the magnetic north vector with respect to the second reference frame, and (8) the second set of displacements of the second UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements in accordance with various aspects of the present disclosure.

FIG. 5 is a diagram illustrating an example of tracking in accordance with various aspects of the present disclosure.

FIG. 6 is a diagram illustrating an example of a tracking device moving through space while measuring time of flight (ToF) distance to a target device in accordance with various aspects of the present disclosure.

FIG. 7 is a diagram illustrating an example procedure for round-trip time (RTT)/ToF estimation between two wireless devices in accordance with various aspects of the present disclosure.

FIG. 8 is a diagram illustrating an example of a smartphone unable to find a moving target in accordance with various aspects of the present disclosure.

FIG. 9 is a diagram illustration an example of a finder device locating a moving target device via an anchor device in accordance with various aspects of the present disclosure.

FIG. 10 is a diagram illustrating an example of a finder device locating a target device via an anchor device in accordance with various aspects of the present disclosure.

FIG. 11 is a diagram illustrating an example of a finder device locating a target device via an anchor device in accordance with various aspects of the present disclosure.

FIG. 12 is a diagram illustrating an example of a finder device locating a target device via an anchor device in accordance with various aspects of the present disclosure.

FIG. 13 is a diagram illustrating an example of a finder device locating a target device via an anchor device in accordance with various aspects of the present disclosure.

FIG. 14 is a diagram illustrating an example of a finder device locating a target device via an anchor device in accordance with various aspects of the present disclosure.

FIG. 15 is a diagram illustrating an example of a finder device locating a target device via an anchor device in accordance with various aspects of the present disclosure.

FIG. 16 is a diagram illustrating an example of a finder device locating a target device via an anchor device in accordance with various aspects of the present disclosure.

FIG. 17 is a diagram illustrating an example user experience of a finder device locating a target device in accordance with various aspects of the present disclosure.

FIG. 18 is a diagram illustrating an example scenario when the finder device and/or the target device move out of the communication range of the anchor device in accordance with various aspects of the present disclosure.

FIG. 19 is a flowchart of a method of wireless communication.

FIG. 20 is a flowchart of a method of wireless communication.

FIG. 21 is a diagram illustrating an example of a hardware implementation for an example apparatus and/or network entity.

### DETAILED DESCRIPTION

Various aspects relate generally to wireless communication and more particularly to tracking and/or ranging based on wireless communication. Some aspects more specifically relate to enable a first device (e.g., a tracking device, a first moving device, etc.) to accurately locate a second device (e.g., a target device, a second moving device, etc.) when they are not within a direct communication range with each other (e.g., at least one of the devices is unable to receive signal(s) transmitted from another device). For example, aspects presented herein may enable two moving devices that are not within a direct communication range to locate each other based on: (a) tracking the relative displacements of the first moving device, (b) tracking the relative displacements of the second moving device, (c) leveraging a common anchor at a fixed location, (d) performing ranging measurements against the common anchor, and (c) exchanging information between devices at each position to determine the transformation between reference frames. By eliminating the need for a direct target-finder visibility (e.g., the specification that the two devices are within a direct communication range with each other), aspects presented herein may extend the tracking/ranging distance over which location service may be provided.

Particular aspects of the subject matter described in this disclosure can be implemented to realize one or more of the following potential advantages. While some conventional tracking mechanisms may enable a finder device to locate a target device without moving (e.g., based on using three-dimensional (3D) angle-of-arrival (AoA) determination), these tracking mechanisms may typically specify the finder device to have multiple antennas (e.g., at least 2 or 4 antennas), which may increase the manufacturing cost of the finder device. In addition, these tracking mechanisms may not work if the finder device and the target device cannot see each other (e.g., are not within a direct communication range of each other), even if they are connected to the same access point (e.g., a base station, a transmission reception point (TRP), a router, etc.). As such, aspects presented herein may improve the applicability of the tracking by enable low-cost/lower-tier devices, such as a single-antenna low-cost phone to perform tracking of another device, where the devices may be specified to move to multiple positions to determine the position of a target device. While the target device 904 may also be specified to move and/or share its displacement information with the finder device, it reduces the manufacturing cost of the devices, and the tracking may work even if two devices far away from each other.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

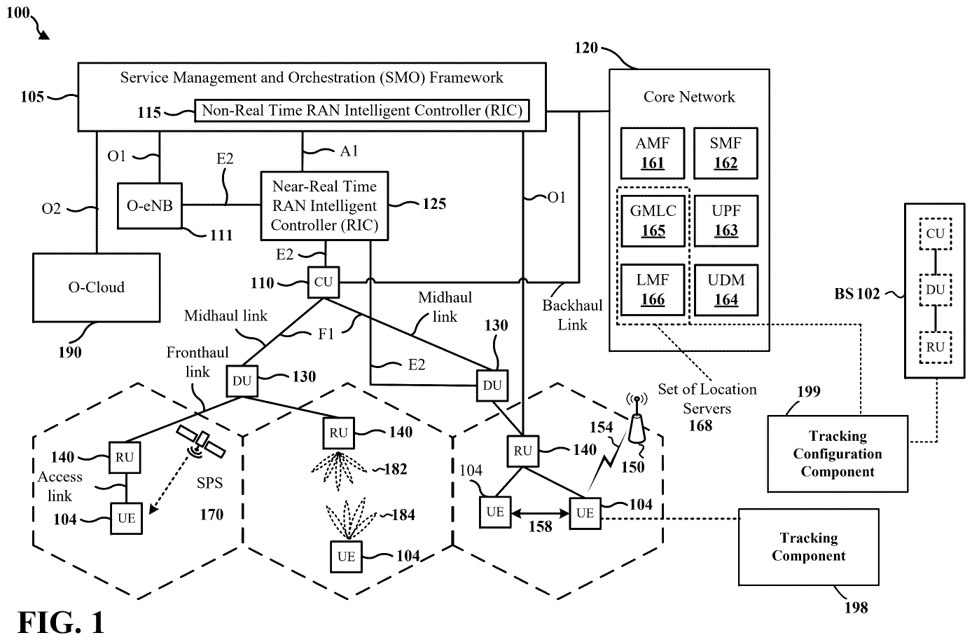

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a tracking component 198 that may be configured to communicate, with a second UE, an anchor device to be used for tracking a position of the second UE; obtain, based on a first reference frame of the first UE, (1) a first set of coordinates of the anchor device with respect to the first reference frame, (2) a second set of coordinates of a gravity vector with respect to the first reference frame, (3) a third set of coordinates of a magnetic north vector with respect to the first reference frame, and (4) a first set of displacements of the first UE; receive, from the second UE, (1) a fourth set of coordinates of the anchor device with respect to a second reference frame of the second UE, (2) a fifth set of coordinates of the gravity vector with respect to the second reference frame, (3) a sixth set of coordinates of the magnetic north vector with respect to the second reference frame, and (4) a second set of displacements of the second UE; and estimate the position of the second UE based on (1) the first set of coordinates of the anchor device with respect to the first reference frame, (2) the second set of coordinates of the gravity vector with respect to the first reference frame, (3) the third set of coordinates of the magnetic north vector with respect to the first reference frame, (4) the first set of displacements of the first UE, (5) the fourth set of coordinates of the anchor device with respect to the second reference frame, (6) the fifth set of coordinates of the gravity vector with respect to the second reference frame, (7) the sixth set of coordinates of the magnetic north vector with respect to the second reference frame, and (8) the second set of displacements of the second UE. In certain aspects, the base station 102 and/or the one or more location servers 168 may have a tracking configuration component 199 that may be configured to provide configurations and/or parameters related to tracking/ranging for the UE 104.

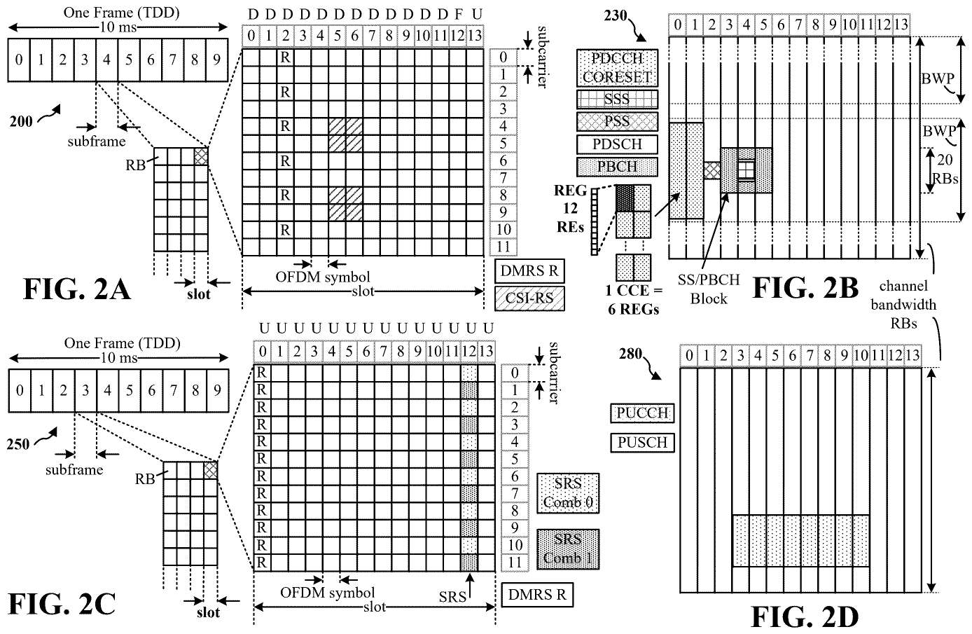

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2″ *15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

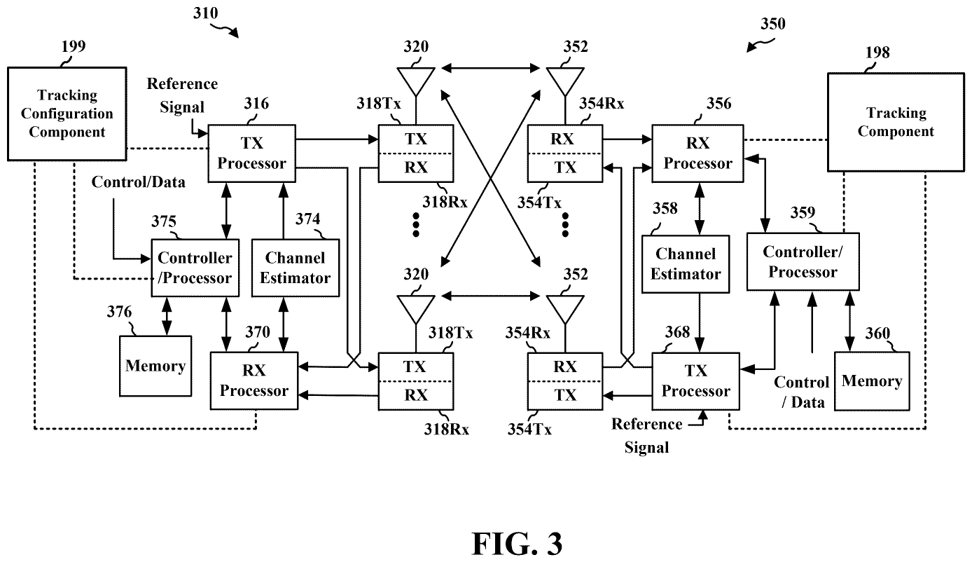

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the tracking component 198 of FIG. 1.

At least one of the TX processor 316, the RX processor 370, and the controller/processor 375 may be configured to perform aspects in connection with the tracking configuration component 199 of FIG. 1.

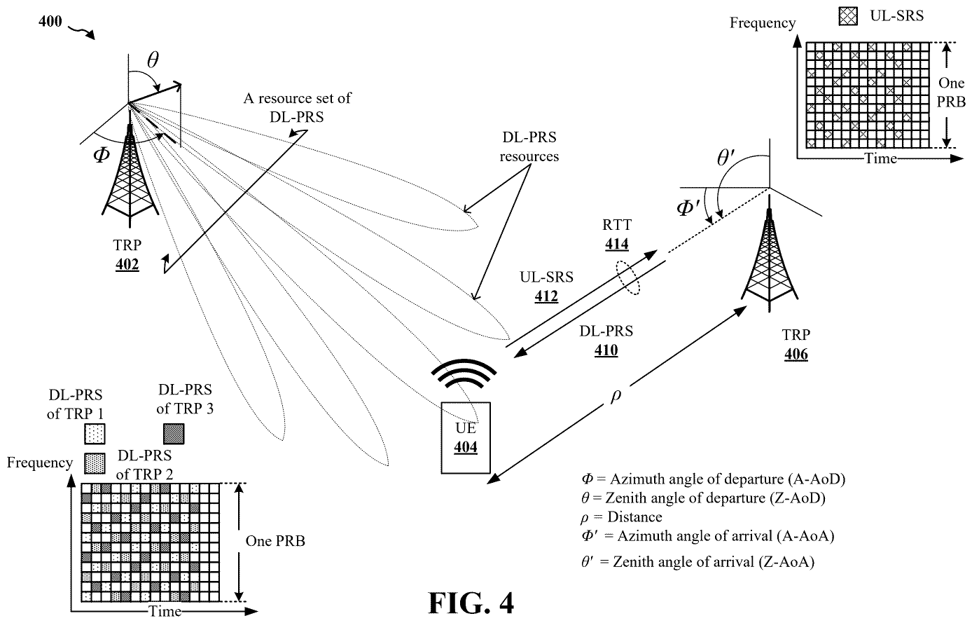

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}-T_{PRS_TX}|−|T_{SRS_TX}-T_{PRS_RX}∥. Accordingly, multi-RTT positioning may make use of the UE Rx-Tx time difference measurements (i.e., |T_{SRS_TX}-T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}-T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle-of-arrival (A-AoA) and zenith angle-of-arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

In addition to the network-based positioning described in connection with FIG. 4, various positioning methods/mechanisms have also been developed for localizing or tracking the position of a target. These positioning methods/mechanisms may be classified into active positioning (which may also be referred to and used interchangeably with “active localization”) and passive positioning (which may also be referred to and used interchangeably with “passive localization”). For active positioning, a wireless device may locate a target based on signals transmitted from the target. For example, the target may be attached or configured with a radio frequency (RF)-capable device/component, such as a tag (e.g., an RF tag), a Global Positioning System (GPS)/wireless tracker, a device/component capable of transmitting/receiving positioning reference signals, a device/component capable of performing or responding to ranging/radar operations, etc. Then, based on signals transmitted from the target (or from the RF-capable device/component attached to the target), the wireless device may calculate or estimate the location of the target (e.g., the relative location, distance, and/or direction of the target from the wireless device). On the other hand, for passive positioning, a target may be localized and tracked without attaching an RF-capable device/component to the target. For example, RF radars, light detection and rangings (Lidars), sonars, and/or cameras are example technologies/components that may be used by a wireless device for passive positioning, where the wireless device may locate a target based on images or based on reflection of signals, etc.

A wireless device may be able to locate and track a target or another wireless device based on using one or more tracking/ranging technologies. For purposes of the present disclosure, tracking technologies may refer to methods and systems that are used for estimating, monitoring, and/or following the movements/locations of a target (e.g., an object, a person, an animal, a vehicle, etc.) over time. Tracking technologies may have different applications across various industries, and may use different principles and devices to achieve the tracking. Depending on implementations, some tracking technologies may be based on ranging operations, which may be referred to as ranging technologies. A ranging operation/technology may refer to a method/technique that is used to measure the distance between two points or objects. An example of ranging operation/technology may include a user locating a target device (e.g., a Bluetooth® device such as a pair of earbuds) using a mobile device (e.g., a smartphone), where the mobile device may continue to estimate the distance and/or location of the target device based on signals from the target device. Depending on the context, in some examples, the term “track/tracking” may be used interchangeably with the term “position/positioning” or “location/locationing.” For example, a wireless device may be configured to track a target based on estimating the position/location of the target using Wi-Fi technologies, which may be referred to as Wi-Fi tracking or Wi-Fi positioning/locationing. Similarly, depending on the context, in some examples, the term “tracking” may be used interchangeably with the term “ranging.” For example, a wireless device may be configured to track a target based on performing ranging against the target using ultra-wideband (UWB) technologies, which may be referred to as UWB/UWB-based tracking or ranging.

The tracking technologies may be used in various fields such as surveying, navigation, robotics, telecommunications, etc. Examples of tracking technologies may include:
(1) global navigation satellite system (GNSS)/global positioning system (GPS) tracking-GNSS/GPS tracking relies on a network of satellites to provide real-time location information. GNSS/GPS receivers, often embedded in devices like smartphones, vehicles, or wearables, may determine their precise location and movement.
(2) radio-frequency identification (RFID) tracking-RFID technology uses radio waves to identify and track objects equipped with RFID tags, where these RFID tags may include electronic information that can be read by RFID readers, enabling the tracking of items in logistics, inventory management, and access control.
(3) Bluetooth® (BT) tracking-Bluetooth technology may be used for tracking by measuring the signal strength between devices. Bluetooth channel sounding (CS) (BTCS) is another technique that may also be used for tracking by measuring the round-trip-time (RTT)/the phase delay of RF signals between devices. Bluetooth beacons or tags may be attached to objects or carried by individuals, and their proximity to Bluetooth receivers may be used to estimate their location.
(4) Wi-Fi® tracking-Wi-Fi tracking may involve using signals from Wi-Fi access points (APs) to estimate the location of target devices. This tracking method is often suitable for indoor environments, such as malls and airports, for tracking people or assets.
(5) cellular tracking—mobile network infrastructure may be able to track devices through the triangulation of cell tower signals. The approximate location of a mobile device can be determined by analyzing the signals it receives from nearby cell towers.
(6) inertial navigation systems—these systems may use accelerometers and gyroscopes to track changes in velocity and orientation.
(7) computer vision tracking-advanced computer vision technologies, including object recognition and tracking algorithms, may enable cameras and sensors to track the movement of objects or people based on visual data.
(8) ultra-wideband (UWB) tracking-UWB tracking may utilize signals with very high frequency ranges or bandwidths. UWB technology transmits data using a broad spectrum of frequencies, enabling precise and accurate tracking of objects or individuals in both indoor and outdoor environments. UWB tracking systems typically operate in the frequency range of 3.1 to 10.6 gigahertz.

As discussed above, ranging operations or technologies may refer to methods or techniques that is used to measure the distance between two points or objects. Examples of ranging operations/technologies may include:
(1) triangulation-triangulation involves measuring the angles between an observer and two known points or landmarks. By using trigonometry, the distance to the object may be calculated or estimated.
(2) time of flight (ToF)—ToF technology measures the time taken for a signal (such as light or sound) to travel from a transmitter to a target and back to a receiver. By knowing the speed of the signal, usually the speed of light or sound, the distance may be calculated or estimated.
(3) GNSS-GNSS systems, such as GPS, global navigation satellite system (GLONASS), Galileo, and BeiDou, use signals from satellites to determine the position of a receiver on Earth. By analyzing the amount of time it takes for signals from multiple satellites to reach the receiver, its position (including distance) may be calculated or estimated.
(4) RFID-RFID technology uses electromagnetic fields to automatically identify and track tags attached to objects. The distance between the reader and the RFID tag may be estimated based on the strength of the received signal.
(5) ultrasonic ranging-ultrasonic ranging involves emitting ultrasonic pulses and measuring the time it takes for the pulses to bounce back from the object. The speed of sound in the medium determines the distance.
(6) laser ranging (e.g., light detection and ranging (Lidar))—laser ranging uses lasers to measure the distance to a target by calculating the time it takes for laser pulses to travel to the target and back.

Among the aforementioned tracking/ranging technologies, in recent years, UWB, Bluetooth, and/or Wi-Fi based tracking/ranging have appeared to be widely used and developed for most wireless devices (e.g., consumer devices such as mobile phones, smart watches, etc.) due to their accessibility and tracking/ranging precisions.

UWB tracking/ranging may refer to using a UWB device/technology to locate and track objects, people, or assets within a certain range. A UWB device (e.g., a device that is capable of performing UWB tracking/ranging) may use pulse-based radio signaling (e.g., Short-pulse-UWB) instead of orthogonal frequency division multiplexing (OFDM)-based signaling (e.g., Multi-Band (MB)-OFDM-UWB (MB-OFDM-UWB)). Short-pulse-UWB signaling may transmit with the energy for each bit spread over the entire UWB channel bandwidth (e.g., 1.37 GHZ, 4 GHZ, etc.) with varying pulse amplitude and/or pulse polarity without using a RF carrier while MB-OFDM-UWB may transmit each bit using a 4 MHz bandwidth channel.

Using short-pulse-UWB signaling systems may provide several advantages over MB-OFDM-UWB signaling systems and other OFDM-based systems. For example, a short-pulse-UWB signaling system may provide better fading characteristics (e.g., Gaussian-modeled fading versus Rayleigh-modeled fading, and/or less than 1% of channels experiencing 2 dB or more fading) than an MB-OFDM-UWB signaling system. As other examples, a short-pulse-UWB signaling system may operate accurately without employing FEC (Forward Error Correction), using no-rake processing, with lower peak-to-average RF, and/or with longer battery life than an MB-OFDM-UWB signaling system. Short-pulse-UWB also does not use traditional modulation and demodulation techniques such as Fast Fourier Transforms (FFT), but may use time-domain or space-time processing techniques. Short-pulse-UWB may utilize various shapes (e.g., Gaussian pulses, Monocycle pulses, Hermite pulses, etc.) and the shape used may be chosen based on their properties in time and frequency domains among other factors, such as Bandwidth utilization, Interference Mitigation, Power Spectral Density, Multipath fading and inter-symbol interference, design complexity, power consumption, range, tradeoffs for ultra-fast sampling, etc. Short-pulse-UWB, in some cases, may benefit from a high-speed Analog-to-Digital converter (ADC) and a high-speed Digital-to-Analog Converter (DAC) to be able to handle the very wide frequency band used; however, there may be other ways to handle the need for ultra-fast sampling such as using Time Hopping techniques, Direct Sequence coding techniques, etc.

MB-OFDM-UWB may divide up spectrum into several frequency sub-bands and OFDM is applied within each band; whereas, other OFDM systems may typically operate within a fixed frequency band. The complex waveform created by combining the multiple-sub-bands results in a final waveform that used for transmission for MB-OFDM-UWB. MB-OFDM-UWB also varies from other OFDM systems by not using a guard interval, using simpler modulation schemes like Binary Phase Shift keying (BPSK) or Quadrature phase-shift keying (QPSK) vs. 64 or 256 Quadrature Modulation (QAM), utilizes a constant power level whereas other OFDM systems may utilize power control for varying channel conditions, etc.

Bluetooth tracking/ranging may refer to using Bluetooth device/technology to locate and track objects, people, or assets within a certain range. This technology may rely on Bluetooth-enabled devices, such as smartphones, tablets, or specialized Bluetooth tags, to communicate with each other and determine their relative positions.

Bluetooth tracking may include beacon-based tracking and Bluetooth low energy (LE) tracking. Beacon-based tracking may involve deploying Bluetooth beacons that emit Bluetooth signals at regular intervals. These signals are picked up by Bluetooth-enabled devices in the vicinity, such as smartphones or tablets. By measuring the signal strength and timing of these beacon signals, the receiving devices can estimate their proximity to the beacon. This information may then be used to determine the location of the Bluetooth-enabled device within the range of the beacon. Bluetooth LE tracking may enable devices to communicate over short distances while consuming minimal power. Bluetooth LE tracking systems may include attaching tags to objects or carried by individuals, and Bluetooth LE receivers (such as smartphones or dedicated receivers) that scan for these tags. The receivers detect the signals transmitted by the tags and use signal strength and other parameters to estimate the distance between the tag and the receivers. By triangulating signals from multiple receivers, the system can determine the location of the tagged object or person. Bluetooth channel sounding (CS) is a technique used in Bluetooth communication to measure time/phase delay of BT signals, such that distance between wireless devices may be estimated/measured more accurately.

Wi-Fi tracking/ranging may refer to using a Wi-Fi capable device/technology for monitoring and tracking the movement of devices within a Wi-Fi network's coverage area. Wi-Fi tracking may rely on the unique media access control (MAC) addresses of Wi-Fi-enabled devices, such as smartphones, tablets, and laptops, to identify and track them as they move within the network's range. For example, Wi-Fi tracking utilizes Wi-Fi access points (APs), which are devices that provide wireless network connectivity to devices within their range. These access points continuously broadcast Wi-Fi signals, allowing Wi-Fi-enabled devices to connect to the network. When Wi-Fi-enabled devices come within range of Wi-Fi access points, they may be configured to automatically send out probe requests, seeking available networks to connect to. Wi-Fi access points receive these probe requests and respond with probe responses containing information about the network, such as the service set identifier (SSID) and signal strength. Each Wi-Fi-enabled device may have a unique MAC address associated with its network interface. Wi-Fi tracking systems capture these MAC addresses from the probe requests and responses exchanged between devices and access points. By monitoring the signal strength and timestamps of probe requests and responses from multiple access points, Wi-Fi tracking systems may triangulate the position of Wi-Fi-enabled devices within the network's coverage area.

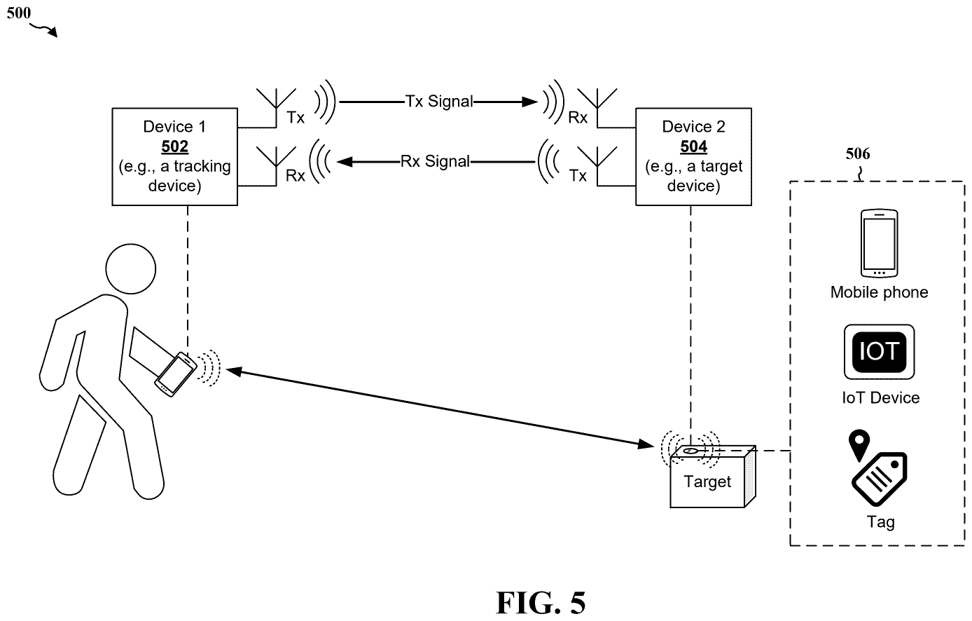

FIG. 5 is a diagram 500 illustrating an example of tracking (e.g., active positioning) in accordance with various aspects of the present disclosure. A first device 502 (which may also be referred to as a “tracking device” or a “finder device” for purposes of the present disclosure) may be able to locate a second device 504 (which may also be referred to as a “target” or a “target device” for purposes of the present disclosure) based on transmitting signals (which may be referred to as “transmission (Tx) signals”) to the second device 504, and receive signals (which may be referred to as “reception (Rx) signals”) from the second device 504. Depending on implementations, the Rx signals may be signals reflected from the second device 504 (e.g., based on the Tx signals) or signals generated by the second device 504. Then, based on the time of-flight (ToF) of the Tx signals and the Rx signals, the first device 502 may estimate the distance of the second device 504 from the first device 502. In some configurations, if the first device is also capable of measuring the angle-of-arrival (AoA) of the Rx signals, the first device 502 may also be able to estimate the direction of the second device 504 from the first device 502 (which may be referred to as the relative direction from the first device 502). As shown at 506, the second device 504 may be a mobile phone, an Internet of Things (IOT) device, or a tag (e.g., an RFID tag), and the localizing and/or tracking of the second device 504 may be based on using Bluetooth® tracking, Wi-Fi tracking, or UWB tracking, etc.

The tracking mechanisms discussed above may have a variety of applications in real life. For example, it is common for users to lose small items (e.g., earbuds, keys, wallets, etc.) somewhere in their home, at work, or in school, and users may often rely on using tracking devices (e.g., their mobile phones) to find those lost items (e.g., earbuds, smart tags, other phones) near them. In some scenarios, a tracking device may just have the capability to identify a rough location of a target device. For example, some tracking devices may be able to just estimate that an item (e.g., a target device) is at a rough location (e.g., at home, at a specific address, at a business, etc.) based on detecting the strength of wireless signals from the item. However, in some scenarios, it may not be enough for users to know that the item is at a rough location, and the users may want to the specific location of the item, such as in a specific room (e.g., in a restroom, bedroom, kitchen, etc.) or in a specific location (e.g., under the bed, on a coach, etc.). As such, accurate positioning/tracking of the target device can be very useful for users.

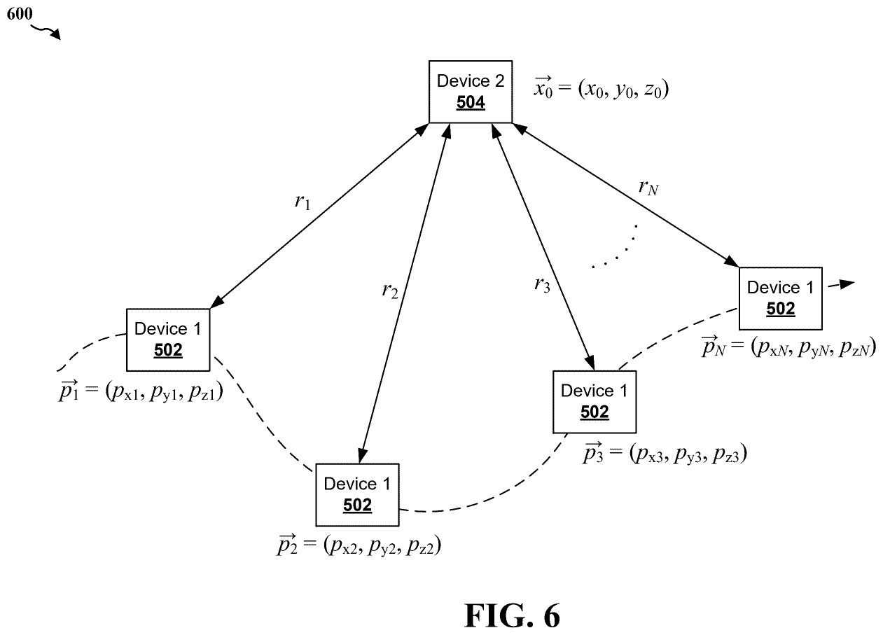

FIG. 6 is a diagram 600 illustrating an example of a tracking device moving through space while measuring time of flight (ToF) distance to a target device in accordance with various aspects of the present disclosure. In one example, a tracking device (e.g., the first device 502, a mobile phone, etc.) may be configured to perform multiple distance measurements rᵢ for a target device (e.g., the second device 504) from multiple positions \vec{p}ᵢ of the tracking based on ToF. For example, when the first device 502 (e.g., the tracking device) is at a first position \vec{p}₁, the first device 502 may measure a first distance r₁ between the first device 502 and the second device 504 (e.g., the target device) based on ToF, such as described in connection with FIG. 5. Similarly, when the first device 502 is at a second position \vec{p}₂, the first device 502 may measure a second distance r₂ between the first device 502 and the second device 504 based on ToF, and so on. Then, based on multiple distance measurements (e.g., r₁ to rₙ) at multiple positionings (e.g., \vec{p}₁ to \vec{p}ₙ), the first device 502 may determine the position of the second device 504, such as based on triangulation.

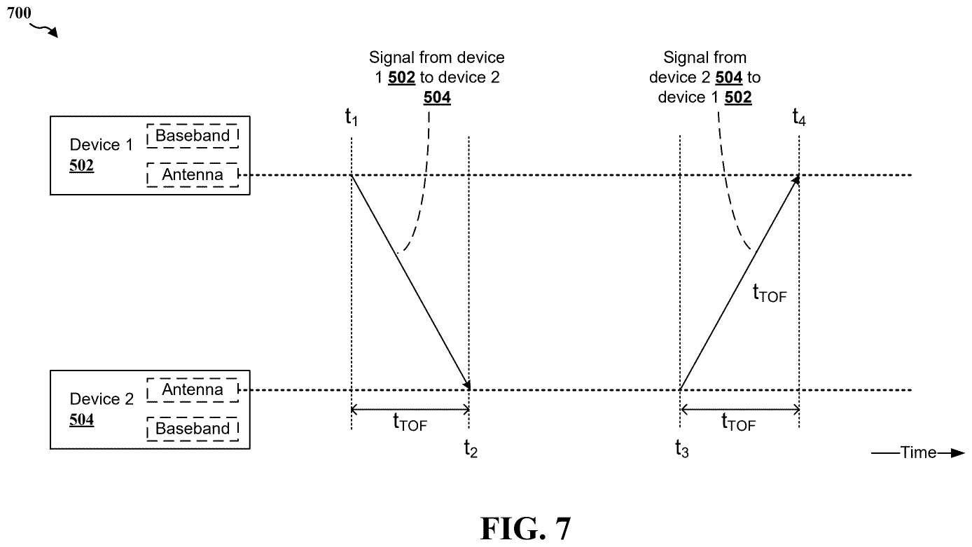

FIG. 7 is a diagram 700 illustrating an example procedure for round-trip time (RTT)/time of flight (ToF) estimation between two wireless devices in accordance with various aspects of the present disclosure. As discussed in connection with FIGS. 5 and 6, wireless tracking/ranging technologies (such as based on UWB, Wi-Fi, or BT, etc.) may rely on measuring the ToF of wireless signals sent between wireless devices. For example, an estimation of the ToF between the first device 502 and the second device 504 may be based on measuring the departure time and the arrival time for a wireless signal, then using the formula:

$${t}_{TOF} = \frac{( {t}_{4} - {t}_{1} ) - ( {t}_{3} - {t}_{2} )}{2}$$

Then the distance (d_{TOF}) between both devices may be estimated by multiplying the speed of light (c):

$${d}_{TOF} = c \cdot {t}_{TOF}$$

This formula and calculation may represent an ideal case and work fine if the times t₁, t₂, t₃, t₄ are able to be accurately measured.

While the example tracking mechanism discussed in connection with FIGS. 5 and 6 may enable a tracking device (e.g., the first device 502) to locate a target device (e.g., the second device 504) based on measuring the distances between them from multiple positions, in some scenarios, the tracking device may not be able to locate the target device if both devices are moving (as opposed to the target being static) and/or if both devices are not within a direct communication range of each other. This may include scenarios such as: (1) Friend A is trying to find Friend B in a large public space where both users are moving; (2) Friends A and B are skiing together and get separated (e.g., both users are moving), Friend A wants to know whether Friend B is higher up in the mountain (in order to wait for Friend B) or lower down (in which case Friend A needs to catch up); and/or (3) a group of fire-fighters are carrying augmented reality (AR) headsets or smart glasses that display the relative position of other team members when they get into a building on fire, where all fire-fighters/users are moving.

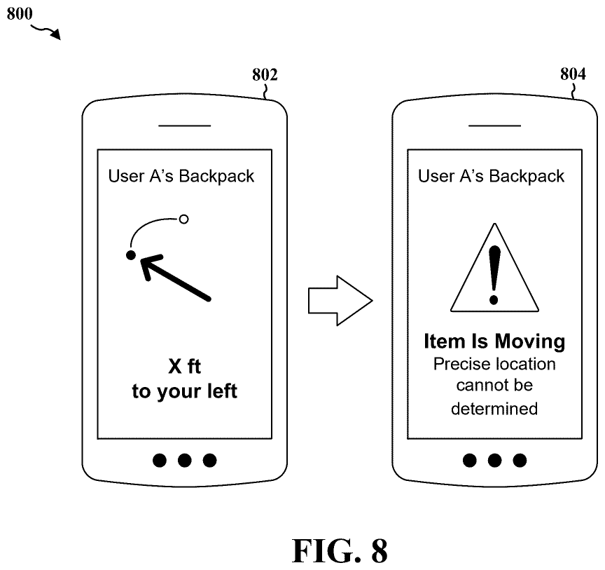

FIG. 8 is a diagram 800 illustrating an example of a smartphone unable to find a moving target in accordance with various aspects of the present disclosure. While most tracking mechanisms may enable one device to locate another device as described in connection with FIG. 5, they may not work (precisely) when the target is moving. For example, as shown at 802, when a user's is trying to find a backpack using a mobile phone (e.g., a backpack that is associated with/attached to a tracker such as an RFID or a tag) while the user is moving, the mobile phone may display directional information of the backpack to the user (e.g., the backpack is X feet to the user's front, back, left, or right, etc.). However, as shown at 804, if the backpack is also moving (e.g., being taken by someone else), the mobile phone may stop providing directional information of the backpack, and may display a warning message that indicates the location/precise location of the backpack cannot be determined. This is likely that the tracking/location algorithm used by the mobile phone specifies/relies on the target (e.g., the backpack) being static. In addition, to find a moving target, some tracking/location algorithms may specify multiple antennas to be used, which may increase the manufacturing cost of the tracking devices.

Also, referring back to FIG. 5, when the first device 502 and the second device 504 are not within a direct communication range with each other (e.g., the first device 502 is unable to receive signals transmitted from the second device 504 and/or vice versa), the first device 502 will not be able to locate the second device.

Aspects presented herein may enable a first device (e.g., a tracking device, a first moving device, etc.) to accurately locate a second device (e.g., a target device, a second moving device, etc.) when they are not within a direct communication range with each other (e.g., at least one of the devices is unable to receive signal(s) transmitted from another device). For example, aspects presented herein may enable two moving devices that are not within a direct communication range to locate each other based on: (a) tracking the relative displacements of the first moving device, (b) tracking the relative displacements of the second moving device, (c) leveraging a common anchor at a fixed location, (d) performing ranging measurements against the common anchor, and (e) exchanging information between devices at each position to determine the transformation between reference frames. By eliminating the need for a direct target-finder visibility (e.g., the specification that the two devices are within a direct communication range with each other), aspects presented herein may extend the tracking/ranging distance over which location service may be provided.

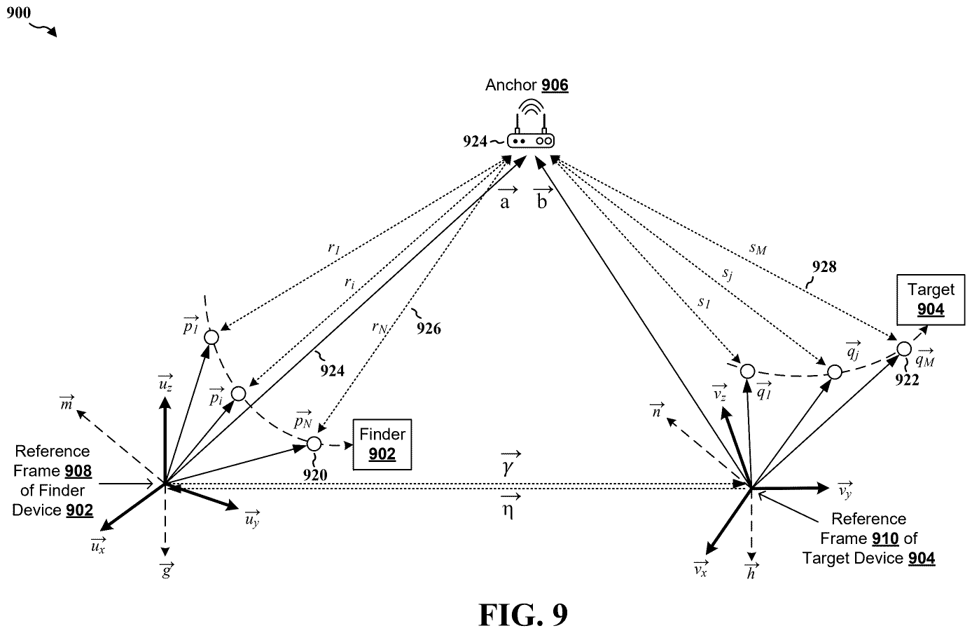

FIG. 9 is a diagram 900 illustration an example of a finder device locating a moving target device via an anchor device in accordance with various aspects of the present disclosure. Aspects presented herein may enable a finder device 902 (e.g., a first UE, a tracking device, etc.) to locate a target device 904 (e.g., a second UE) and/or vice versa when the finder device 902 and the target device 904 are not within a direct communication with each other, and also when they are moving/mobile. In one aspect, as shown at 920, the finder device 902 may be configured to track its displacement (\vec{pₜ}) based on a reference frame 908 of the finder device 902 ({\vec{uₓ}, \vec{u_{y}}, \vec{u_{z}}}). Similarly, as shown at 922, the target device 904 may also be configured to track its displacement (\vec{q_{J}}) based on a reference frame 910 of the target device 904 ({\vec{vₓ}, \vec{v_{y}}, \vec{v_{z}}}). Then, as shown at 924, the finder device 902 and the target device 904 may be configured to find and leverage an anchor device 906 (e.g., a base station, a TRP, an access point (AP), a Wi-Fi AP, etc.) that is at a fixed location, and perform ranging measurements against the anchor device 906. For example, as shown at 926, the finder device 902 may perform ranging measurements against the anchor device 906, such as measuring a set of time of flight (ToF) distances (rᵢ) to the anchor device 906. Similarly, as shown at 928, the target device 904 may also perform ranging measurements against the anchor device 906, such as measuring a set of ToF distances (sᵢ) to the anchor device 906. Then, the finder device 902 and the target device 904 may exchange their information/measurements (at multiple/different positions) to determine the transformation between their reference frames (e.g., between the reference frame 908 and the reference frame 910), and estimate the relative location between them using the transformed reference frames.

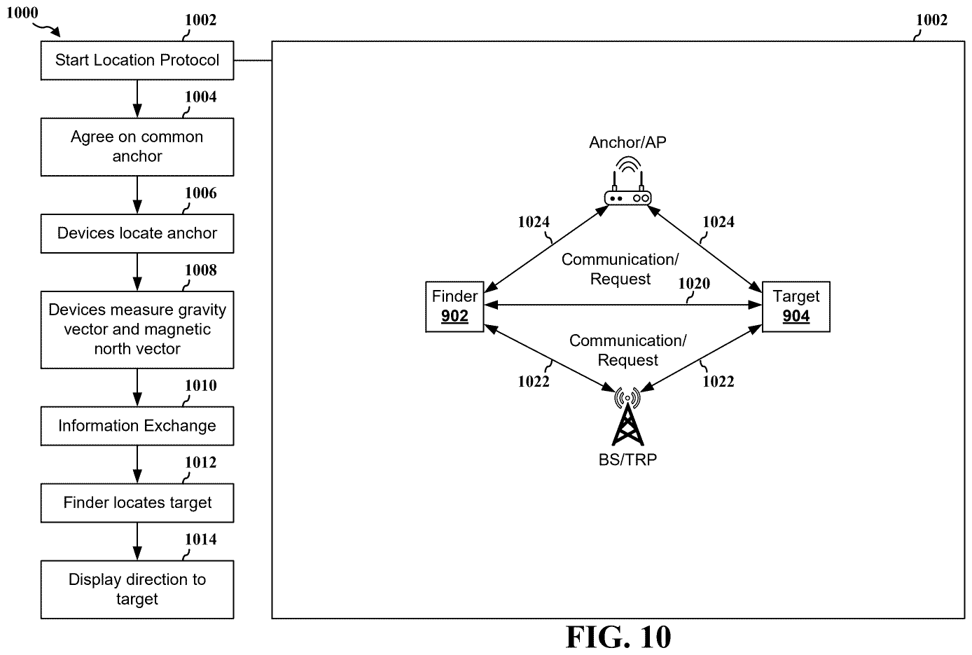

Table 2 below provides a list of variables associated with the finder device 902 and the target device 904 in the diagram 900, which may be used for describing aspects of the present disclosure in connection with FIGS. 10 to 16 below.

TABLE 2
List of Variables Associated with Finder Device and Target Device

| | Reference Frame of | Reference Frame of |
|---|---|---|
| | Finder Device | Target Device |
| Unit vectors for | {\vec{uₓ}, \vec{u_{y}}, \vec{u_{z}}} | {\vec{vₓ}, \vec{v_{y}}, \vec{v_{z}}} |
| Reference Frame | | |
| Reference Frame as | U = [\vec{uₓ}, \vec{u_{y}}, \vec{u_{z}}] | V = [\vec{vₓ}, \vec{v_{y}}, \vec{v_{z}}] |
| matrix | | |
| Position of the other | \vec{γ} | \vec{η} |
| reference frame | | |
| Device position (e.g., | \vec{p_{ι}} | \vec{qⱼ} |
| measured by visual | | |
| inertial odometry (VIO)) | | |
| Number of | N | M |
| measurements | | |
| Time of flight (ToF) | rᵢ | sᵢ |
| distance to anchor | | |
| Estimated anchor | \vec{a} | \vec{b} |
| position in local | | |
| coordinates | | |
| Gravity unit vector | \vec{g} | \vec{h} |
| Magnetic North unit | \vec{m} | \vec{n} |
| vector | | |

FIGS. 10 to 16 are diagrams 1000 to 1600 illustrating an example of a finder device locating a target device via an anchor device in accordance with various aspects of the present disclosure. As shown by the diagram 1000 of FIG. 10, at 1002, the finder device 902 and the target device 904 (collectively referred to as “devices”) may communicate with each other regarding an initiation of a tracking session. For example, the finder device 902 may send a request to the target device 904 to indicate that the finder device 902 is going to track the position of the target device 904 (or want to estimate the position of target device 904). In response, the target device 904 may transmit an acknowledgement (ACK) or a confirmation if the target device 904 accepts the request. In some implementations, the devices may also communicate and agree on at least one communication protocol (e.g., 4G LTE/5G NR, Bluetooth®, Wi-Fi, UWB, etc.) for the tracking session. Depending on implementations/scenarios, the devices may communicate directly with each other if they are in a direct communication with each other as shown at 1020, communicate with each other via a cellular network as shown at 1022, and/or via an anchor device or access point (AP) if applicable as shown at 1024. Such communication(s) may collectively be referred to as an out of band (OOB) communication.

In other words, the devices may agree that the finder device 902 is going to track the position of the target device 904 based on an OOB communication (or based on some OOB protocol(s)), where the OOB communication may happen through any means (e.g., via a cellular connection, via a Wi-Fi connection using the same AP or different APs, or through some peer-to-peer (P2P) link that does not support ToF ranging, etc.). Aspects described in connection with FIG. 10 may assume that the devices are capable of communicating with each other, typically using some network infrastructure, or using some direct P2P mechanism that enables communication but not direct ToF estimation. It may also be assumed that there is a mechanism in place to decide that one device is allowed to track the other device. For example, both devices may be part of a family or friend group, or both devices may be using a ride-share app that enables a “driver” and a “customer” to share location information temporarily, etc.

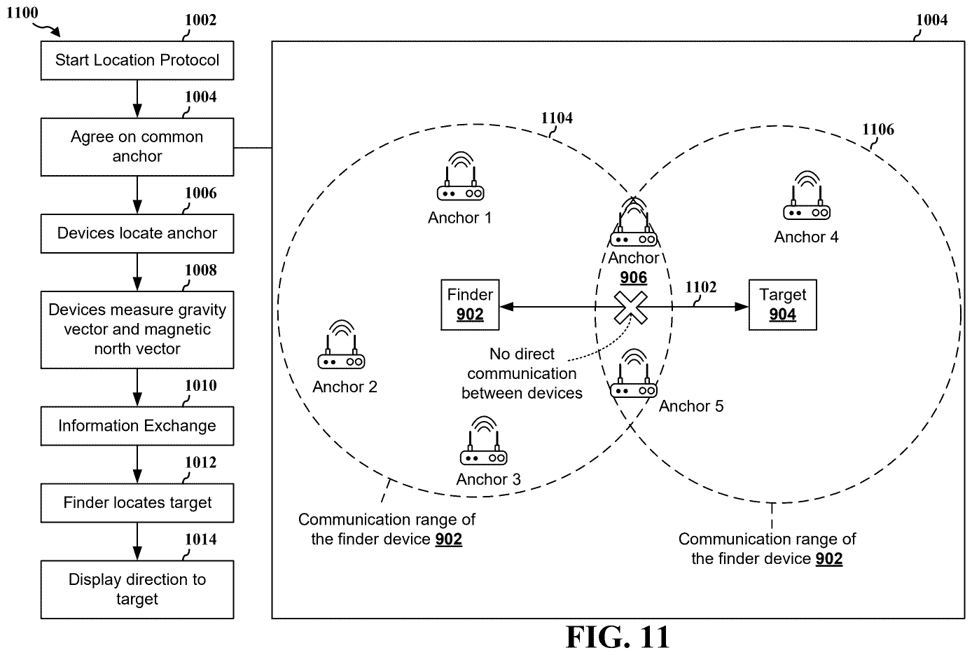

As shown by the diagram 1100 of FIG. 11, at 1004, the finder device 902 and the target device 904 may exchange information with each other about nearby anchors, and the devices may agree to use a common anchor device that both can see (e.g., are able to communicate with), and also this common anchor device supports ranging (e.g., ToF ranging). Depending on implementation, the specific radio type and frequency band to be used by the finder device 902 and the target device 904 may be different.

For example, as shown at 1102, both devices may be configured to first check whether they are within the reach of each other (e.g., with a direct communication range of each other). If the devices are within the reach of each other and are able to directly estimate their mutual distance, then they may perform the tracking/ranging without an anchor device, such as using the tracking mechanism described in connection with FIGS. 5 and 6.

On the other hand, if (and assuming) the devices are not within the reach of each other (e.g., are not able to communicate directly with each other), both devices may be configured to search/scan for nearby anchors, and collect a list of candidate anchors. For example, as shown at 1104, the finder device 902 may search for anchor devices that are within its communication range, and the finder device 902 may find a list of candidate anchors that includes a first anchor (anchor 1), a second anchor (anchor 2), a third anchor (anchor 3), a fifth anchor (anchor 5), and the anchor device 906. Similarly, as shown at 1106, the target device 904 may search for anchor devices that are within its communication range, and the target device 904 may find a list of candidate anchors that includes a fourth anchor (anchor 4), the fifth anchor (anchor 5), and the anchor device 906.

After finding the list of candidate anchors, the devices may exchange the list of candidate anchors with each other, such as use the existing OOB communication protocol(s)/channel(s) described in connection with FIG. 10. Then, the devices may agree on at least one candidate anchor that is in both lists of candidate anchors, such as the anchor device 906. For example, after exchanging the list of candidate anchors with each other, both devices may observe that the fifth anchor (anchor 5) and the anchor device 906 are anchors within both of their communication/ranging ranges. At least one of the devices (e.g., the finder device 902) may determine the anchor device 906 is to be used, and transmit an indication to use the anchor device 906 to another device (e.g., the target device 904), and receive an acknowledgement/confirmation from another device that the anchor device 906 is to be used for the tracking session.

In addition, in selecting the anchor device to be used for the for the tracking session from the lists of candidate anchors, the selection may specify that both devices are able to simultaneously measure the ToF/RTT against the same anchor device. However, the devices may (1) use different frequencies to measure the ToF/RTT against the same anchor device (e.g., the finder device 902 uses 5 GHz Wi-Fi and the target device 904 uses 6 GHz Wi-Fi); (2) use different channel bandwidth to measure the ToF/RTT against the same anchor device (e.g., the finder device 902 uses 80 MHz and the target device 904 uses 160 MHZ); and/or (3) use different radio technologies to measure the ToF/RTT against the same anchor device (e.g., the finder device 902 uses Wi-Fi and the target device 904 uses UWB). Depending on implementations, the common anchor device (e.g., the anchor device 906) may not be aware that both devices are trying to find each other, as the common anchor device may not be actively involved in the end-to-end algorithm. The responsibility of the anchor may just be performing the ToF/RTT measurements against each device.

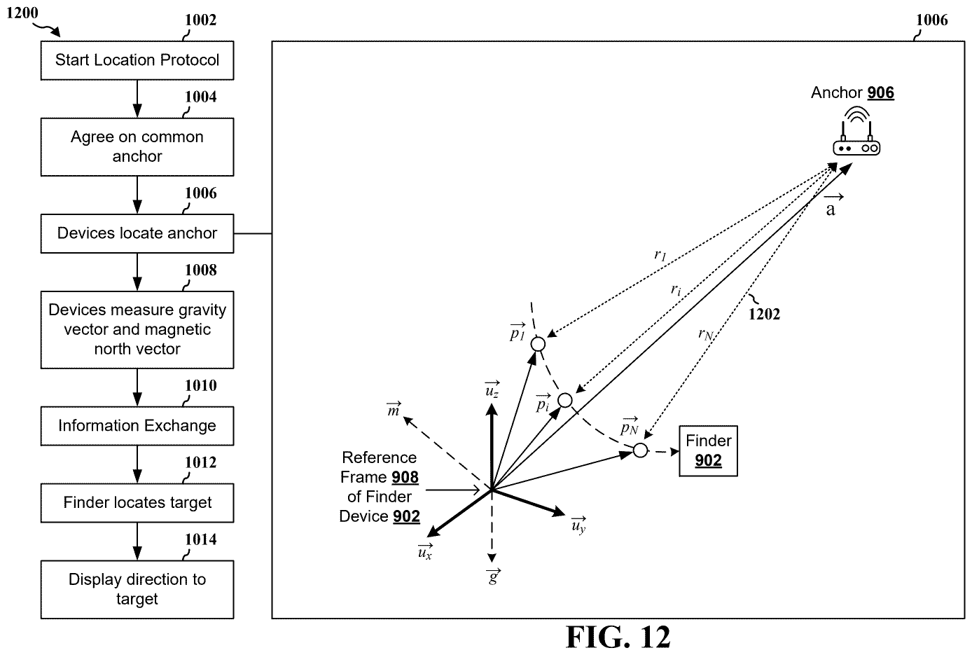

As shown by the diagram 1200 of FIG. 12, at 1006, each of the finder device 902 and the target device 904 may perform ranging against the anchor device 906 to estimate the position of the anchor device 906 in their own local reference frame, where their local reference frames are assumed to be different. For example, as shown at 1202 and also illustrated by the diagram 900 of FIG. 9, the finder device 902 may perform ranging against the anchor device 906 to estimate the position of the anchor device 906 in its local reference frame 908. Similarly, as illustrated by the diagram 900 of FIG. 9, the target device 904 may perform ranging against the anchor device 906 to estimate the position of the anchor device 906 in its local reference frame 910.

In one example implementation, to estimate the position of the anchor device 906 in its local reference frame, the finder device 902 and/or the target device 904 may be configured to build a loss function μ(·) (e.g., with {\vec{pₗ}, rᵢ} or {\vec{qₗ}, sᵢ}) and estimate the position of the anchor device 906 based on minimizing the loss function. For example, an example loss function for the finder device 902 (μ_{F} (\vec{x})) may be represented with:

$${μ}_{F} ( \vec{x} ) = {\sum }_{i = 1}^{N} {( \frac{‖ \vec{x} - \vec{{p}_{i}} ‖ - {r}_{i}}{{σ}_{i}} )}^{2}$$

where N is the number of ranging (ToF/RTT) measurements, \vec{pₗ} is the position of the finder device 902 (e.g., may be tracked/measured using inertial measurement unit (IMU) and/or VIO, etc.), rᵢ is the (ToF) distance from the finder device 902 to the anchor device 906, and σᵢ is the standard deviation of the ToF measurement process for rt. Then, the finder device 902 may estimate the position (a) of the anchor device 906 in its reference frame 908 based on minimizing the loss function μ_{F}(\vec{x}):

$$\vec{a} = {arg min}_{\vec{x}} \{ {μ}_{F} ( \vec{x} ) \}$$

Similarly, an example loss function for the target device 904 (μ_{T} (\vec{x})) may be represented with:

$${μ}_{T} ( \vec{x} ) = {\sum }_{j = 1}^{M} {( \frac{‖ \vec{x} - \vec{{q}_{j}} ‖ - {s}_{j}}{{σ}_{j}} )}^{2}$$

where M is the number of ranging (ToF/RTT) measurements, \vec{q_{J}} is the position of the target device 904 (e.g., may be tracked/measured using IMU and/or VIO, etc.), sⱼ is the (ToF) distance from the target device 904 to the anchor device 906 and of is the standard deviation of the ToF measurement process for sⱼ. Then, the target device 904 may estimate the position (\vec{b}) of the anchor device 906 in its reference frame 910 based on minimizing the loss function μ_{T}(\vec{x}):

$$\vec{b} = {arg min}_{\vec{x}} \{ {μ}_{T} ( \vec{x} ) \}$$

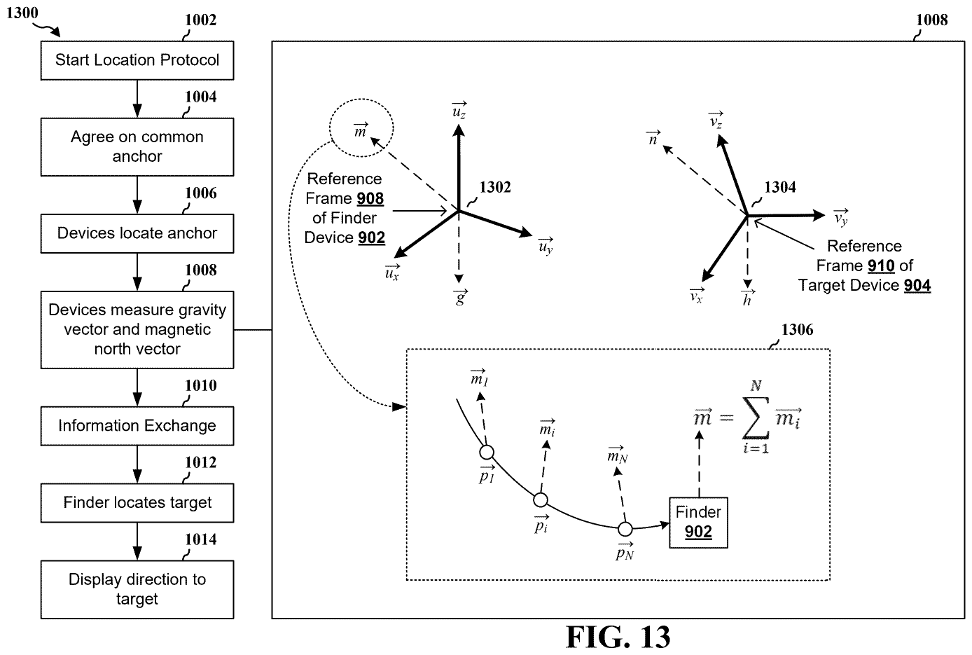

As shown by the diagram 1300 of FIG. 13, at 1008, based on that the gravity vectors for both devices are likely to point in the same physical direction, and that the magnetic north vectors for both devices are also likely to point roughly in the same direction (but may not be exactly, so both devices may be configured to collect multiple samples and average them out), the devices may use the gravity vector and the magnetic north vector to find a transformation between their reference frames (e.g., converting the reference frame or another device to its local reference frame).

For example, after the finder device 902 and the target device 904 have determined the position of the anchor in their respective local reference frames, they may need to consider additional data points in order to find the right transformation between the reference frame 908 of the finder device 902 and the reference frame 910 of the target device 904. One example of such additional data points may include the direction of the gravity and the direction of the magnetic north as these two physical magnitudes are likely to be equal (or very similar) for both devices, when measured in the same reference frame.

Thus, as shown at 1302, the finder device 902 may be configured to find the gravity unit vector (\vec{g}) and the magnetic north unit vector (\vec{m}) in its reference frame 908, such as using sensor(s) (e.g., an IMU, a magnetometer, etc.). Similarly, as shown at 1304, the target device 904 may be configured to find the gravity unit vector (\vec{h}) and the magnetic north unit vector (\vec{n}) in its reference frame 910, such as using sensor(s). After each device determines both unit vectors in their local reference frame, they may exchange that information with each other. For example, the finder device 902 may provide the gravity unit vector (\vec{g}) and the magnetic north unit vector (\vec{m}) in its reference frame 908 to the target device 904, and/or the target device 904 may provide the gravity unit vector (\vec{h}) and the magnetic north unit vector (\grave{n}) in its reference frame 910 to the finder device 902. Note the use of the gravity unit vector and/or the magnetic north unit vector are merely for illustrative purposes. Depending on implementations, the devices may also be configured to provide a negative gravity vector instead of the gravity vector, and/or tracking the magnetic cast, west, or south direction instead of the magnetic north. As such, these variations are to be construed within the scope of the present disclosure.

In some scenarios, when the devices are indoors, the local magnetic field may be affected by nearby objects like pillars, metallic structures, etc. For this reason, the magnetic field (e.g., the magnetic north) in two points of the same building may be pointing in different directions. As such, in another aspect of the present disclosure, to obtain a better or a more accurate estimate of the true magnetic north, the finder device 902 and/or target device 904 may be configured to sample the magnetic field from multiple positions, and then compute the average of the samples to determine the magnetic north. For example, as shown at 1306, the finder device 902 may be configured to sample the magnetic fields (\vec{m₁} to \vec{m_{N}}) from multiple positions (\vec{p₁} to \vec{p_{N}}). Then, the finder device 902 may determine the magnetic north unit vector (\vec{m}) based on averaging the magnetic fields from the multiple positions:

$$\vec{m} = \frac{1}{N} {\sum }_{i = 1}^{N} \vec{{m}_{i}}$$

Similarly, the target device 904 may be configured to sample the magnetic fields (\vec{n₁} to \vec{n_{M}}) from multiple positions (\vec{q₁} to \vec{q_{M}}). Then, the target device 904 may determine the magnetic north unit vector (\vec{n}) based on averaging the magnetic fields from the multiple positions:

$$\vec{n} = \frac{1}{M} {\sum }_{i = 1}^{M} \vec{{n}_{i}}$$

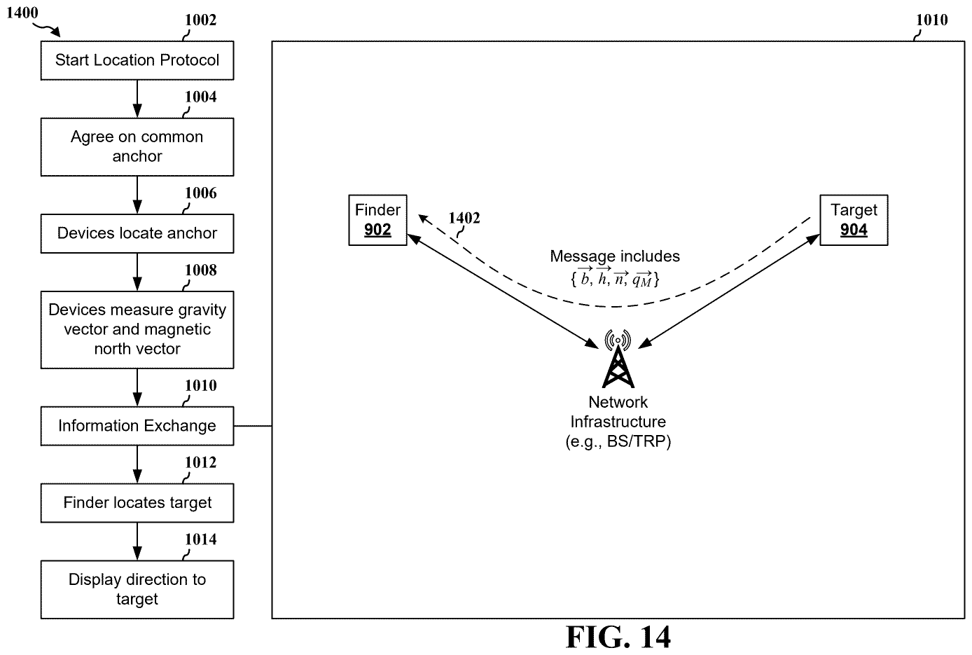

As shown by the diagram 1400 of FIG. 14, at 1010, the finder device 902 and the target device 904 may exchange various information with each other. As the devices now have all the information specified to compute the relative position of all devices, the information may need to be consolidated in one place (e.g., at one of the devices) to perform the computation. For example, as shown at 1402, one implementation is for the target device 904 to transmit the following information to the finder device 902 (measured in the local reference frame 910 of the target device 904): coordinates of the anchor device 906 (\vec{b}), gravity vector (\vec{h}), magnetic north vector (\vec{n}), and the (latest/current) position of the target device 904 (\vec{q_{M}}). In another example, or as an alternative implementation, the target device 904 may send, to the finder device 902, its displacements (\vec{q_{J}}), distances (e.g., ToF distances), and the standard deviation (σⱼ) of the ToF measurement process for sⱼ (e.g., {\vec{q_{J}}, sⱼ, σⱼ}) instead of \vec{b}, so that the finder device 902 may compute b locally. This implementation may be suitable when the target device 904 does not have the specified computing resources.

Similarly, if the target device 904 is also configured to track the location of the finder device 902, the finder device 902 may transmit the following information to the target device 904 (measured in the local reference frame 908 of the finder device 902): coordinates of the anchor device 906 (\vec{a}) (or {\vec{pₗ}, rᵢ, σᵢ}), gravity vector (\vec{g}), magnetic north vector (\vec{m}), and the (latest/current) position of the finder device 902 (\vec{p_{N}}).

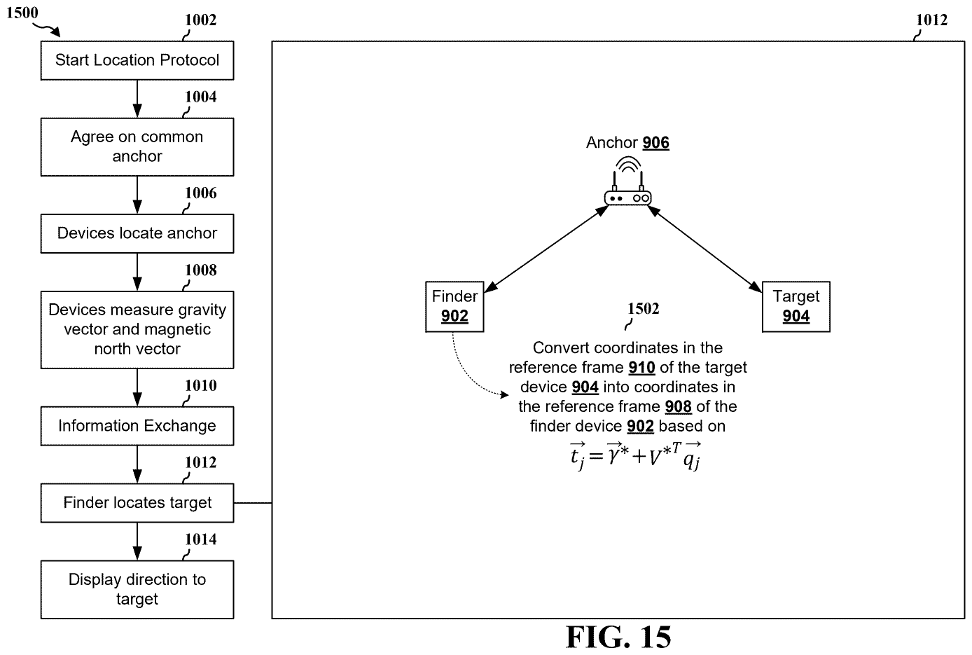

As shown by the diagram 1500 of FIG. 15, at 1012, after the information exchange, the devices may be able to locate each other. For example, the finder device 902 may use the following information to estimate the reference frame 910 of the target device 904: (1) coordinates of the anchor device 906 (in the reference frame 908 of the finder device 902 and the reference frame 910 of the target device 904), (2) gravity vector coordinates (in the reference frame 908 of the finder device 902 and the reference frame 910 of the target device 904), and (3) magnetic north vector coordinates (in the reference frame 908 of the finder device 902 and the reference frame 910 of the target device 904). After the reference frame 910 of the target device 904 is computed, the finder device 902 may use it to obtain the position of the target device 904.

As an illustration, after the finder device 902 obtains the information specified to determine the position of the target device 904, the finder device 902 may first compute the transformation for converting the reference frame 910 of the target device 904 to the reference frame 908 of the finder device 902. For example, a candidate offset between the reference frame 910 of the target device 904 and the reference frame 908 of the finder device 902 (from the perspective of the finder device 902) may be calculated based on:

$$\vec{γ} = {[ \begin{matrix}{γ}_{x} & {γ}_{y} & {γ}_{z}\end{matrix} ]}^{T} ∈ {ℝ}^{3}$$

The Euler angles to generate a candidate orthogonal matrix V (e.g., V=the reference frame 910 of the target device 904 as a matrix) may be based on:

$$\vec{α} = {[ \begin{matrix}{α}_{1} & {α}_{2} & {α}_{3}\end{matrix} ]}^{T} ∈ {[ 0 , 2 π ]}^{3}$$

where notation for compact description of V may be represented with:

$${c}_{i} = cos ( {α}_{i} )$$

$${s}_{i} = sin ( {α}_{i} )$$

Then, the finder device 902 may use the equation above to transform \vec{q_{M}} (e.g., the latest/current position of the target device 904 in the reference frame 910 of the target device 904) into the reference frame 908 of the finder device 902. A formula for generating an orthogonal matrix V with Euler angles given above may be represented by:

$$V ( \vec{α} ) = ( \begin{matrix}{c}_{1} {c}_{2} & {c}_{1} {s}_{2} {s}_{3} - {s}_{1} {c}_{3} & {c}_{1} {s}_{2} {c}_{3} + {s}_{1} {s}_{3} \\ {s}_{1} {c}_{2} & {s}_{1} {s}_{2} {s}_{3} + {c}_{1} {c}_{3} & {s}_{1} {s}_{2} {c}_{3} - {c}_{1} {s}_{3} \\ - {s}_{2} & {c}_{2} {s}_{3} & {c}_{2} {c}_{3}\end{matrix} )$$

Then, based on the foregoing, the finder device 902 may estimate the values for \vec{γ} and V.

In one aspect of the present disclosure, the finder device 902 may estimate the values for \vec{γ} and V based on building a loss function and finding an optimal value (e.g., may be a maximum value or a minimum value depending on implementation) for the loss function. For example, a possible loss function algorithm to estimate the most likely (i.e., optimal) values for \vec{γ} and V may be:

$$μ ( \vec{γ} , \vec{α} ) = μ ( \vec{γ} , V ( \vec{α} ) ) = {‖ \vec{a} - ( γ + {V}^{T} \vec{b} ) ‖}^{2} + {‖ \vec{m} - {V}^{T} \vec{n} ‖}^{2} + {‖ \vec{g} - {V}^{T} \vec{h} ‖}^{2}$$

where values for ∥\vec{a}−(γ+V^{T}\vec{b})∥², ∥\vec{m}−V^{T} \vec{n}∥², and ∥\vec{g}−V^{T} \vec{h}∥² are small (or zero) if the values are close to the target (e.g., loss function ( [symbol] to be minimized). Then, the tuple of parameters that minimize the loss function may be represented as:

$$( \vec{{γ}^{*}} , \vec{{α}^{*}} ) = {arg min}_{( \vec{γ} , \vec{α} )} \{ μ ( \vec{γ} , V ( \vec{α} ) ) \}$$

where various minimization techniques may be used for minimizing the loss function, such as using a gradient descent minimization technique. Based on the loss function and the minimization technique, as shown at 1502, the finder device 902 may convert position(s) (e.g., coordinates) in the reference frame 910 of the target device 904 into the position(s) (e.g., coordinates) in the reference frame 908 of the finder device 902 based on:

$$\vec{{t}_{j}} = \vec{{γ}^{*}} + {V}^{* T} \vec{{q}_{j}}$$

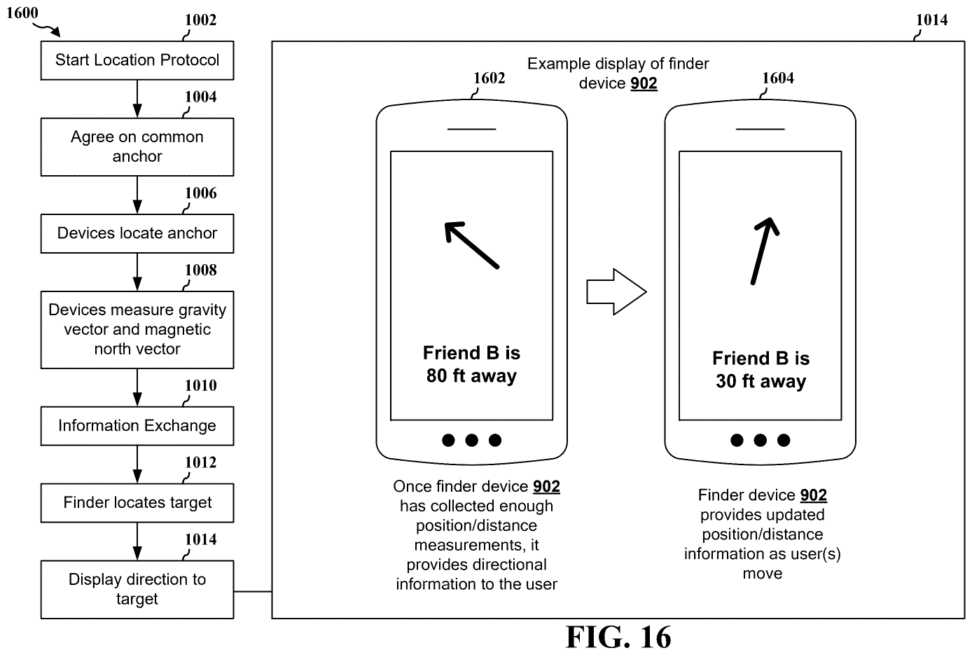

Note the calculations/algorithms above are merely for illustrative purposes. There are many other algorithms that may be used for computing \vec{γ} and V given the same inputs. As shown by the diagram 1600 of FIG. 16, at 1014, the finder device 902 may use information about the position of the target device 904 (in the local reference frame 908 of the finder device 902) to display directional information to the user of the finder device 902. For example, after the finder device 902 has the optimal estimates for \vec{γ} and V, the finder device 902 may compute the position of the target device 904 by transforming future position (\vec{q}ⱼ) of the target device 904 into the reference frame 908 of the finder device 902 using \vec{t}_{J}=\vec{γ*}+V^{*T} \vec{q_{J}}, where \vec{t_{J}}, is the position of the target device 904 in the reference frame 908 of the finder device 902 and \vec{q_{J}} is the new position reported by the target device 904 in its own reference frame 910.

Then, the finder device 902 may display the directional information of the target device 904 to its user, such as via a user interface (UI). Depending on implementations, the finder device 902 may be configured to take into account its own orientation when displaying the directional information (e.g., an arrow) to the user. For example, as shown at 1602, after the finder device 902 (or an application (app) running on the finder device) has collected sufficient position/distance measurements, it may provide directional information to the user, such as the target device 904 (or the user associated with the target device 904) is X feet/meters away in certain direction. As shown at 1604, the finder device 902 may continue to provide updated position/distance information of the target device 904 as the user of the finder device 902 and/or the user of the target device 904 move.

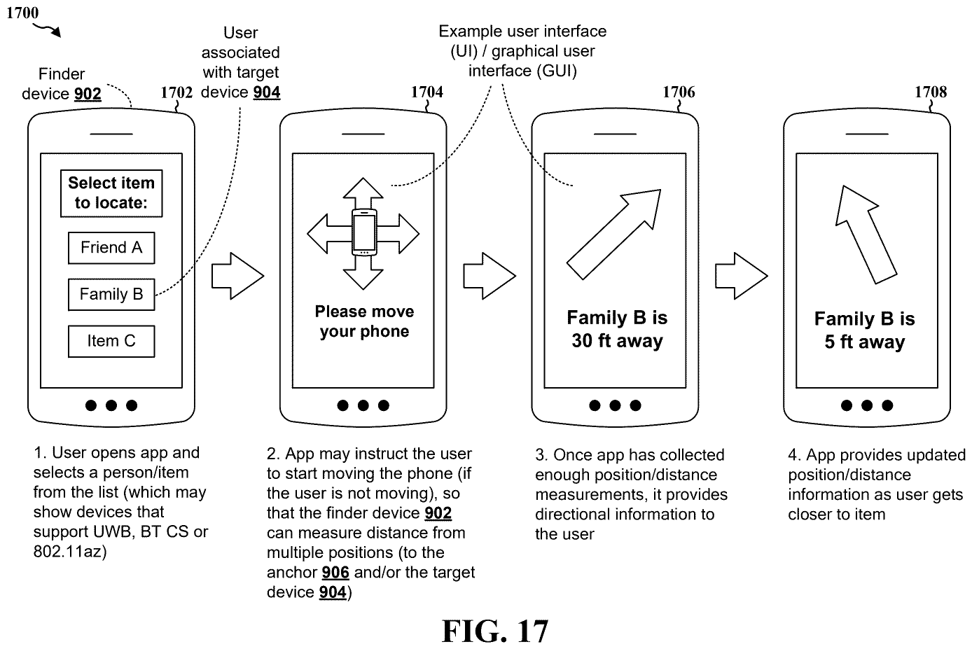

FIG. 17 is a diagram 1700 illustrating an example user experience of a finder device locating a target device in accordance with various aspects of the present disclosure. As shown at 1702, the finder device 902 (e.g., a mobile phone) or an application running on the finder device 902 may instruct the user to select a person/item (e.g., from a list of detected people/items) for tracking/locating. As shown at 1704, after the user selects a person/item (e.g., a family member B) that is associated with the target device 904 (e.g., a mobile phone), the finder device 902 may instruct the user to move the finder device 902, such that the finder device 902 may be able to measure the distance between the finder device 902 and the anchor device 906/target device 904 from multiple positions (e.g., as described in connection with FIG. 6). As shown at 1706, after the finder device 902 has collected sufficient position/distance measurements (e.g., a minimum of three), the finder device 902 may start providing directional information of the target device 904 to the user, such as by showing the direction and the distance of the target device 904 with respect to the finder device 902. Then, as shown at 1708, the finder device 902 may continue to update the directional information of the target device 904 as the user(s) move, and may stop the update after the user locates the target device 904 (e.g., after the finder device 902 is within a threshold distance of the target device 904).

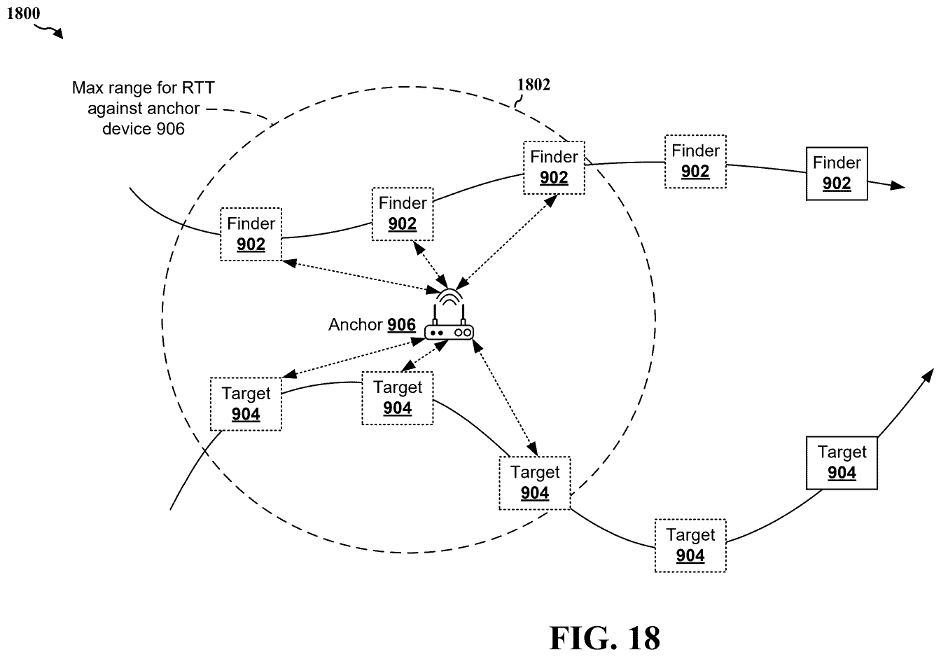

FIG. 18 is a diagram 1800 illustrating an example scenario when the finder device and/or the target device move out of the communication range of the anchor device in accordance with various aspects of the present disclosure. As shown at 1802, after the finder device 902 has estimated the (\vec{γ}, V) transformation between both the reference frame 908 of the finder device 902 and the reference frame 910 of the target device 904, the finder device 902 may continue to track the position of the target device 904, provided the target device 904 is capable of continue to send updates for {\vec{q_{J}}} even if any of the two devices goes out of range of the common anchor device 906. In other words, after the transformation between the reference frames of the finder device 902 and the target device 904 are obtained, the devices may locate/track each other without the common anchor device 906.

In some implementations, the devices may also be configured to (periodically) check whether they are within a direct communication range of each other. If the devices detect that they are within a direct communication range of each other, the devices may switch back to direct tracking/ranging mechanisms such as described in connection with FIGS. 5 and 6 instead of performing tracking/ranging via an anchor device.

Aspects presented herein provide techniques that may enable a moving finder device to find a moving target device using one antenna when both devices have the capability to measure and track their own displacements. In one aspect, a target device may track its own relative position/orientation (relative to its own reference frame) and send the information to the finder device, which may also track its own position/orientation (relative to its own reference frame) along with the ranges from the target devices at different points. Then the finder device may run an algorithm (building and minimizing a loss function) to estimate the reference frame of the target, thereby estimating the actual position of the target.

While some conventional tracking mechanisms may enable a finder device to locate a target device without moving (e.g., based on using three-dimensional (3D) angle-of-arrival (AoA) determination), these tracking mechanisms may specify the finder device to have multiple antennas (e.g., at least 2 or 4 antennas), which may increase the manufacturing cost of the finder device. In addition, these tracking mechanisms may not work if the finder device and the target device cannot see each other (e.g., are not within a direct communication range of each other), even if they are connected to the same access point (e.g., a base station, a TRP, a router, etc.). As such, aspects presented herein may improve the applicability of the tracking by enable low-cost/lower-tier devices, such as a single-antenna low-cost phone to perform tracking of another device, where the devices may be specified to move to multiple positions to determine the position of a target device. While the target device 904 may also be specified to move and/or share its displacement information with the finder device, it reduces the manufacturing cost of the devices, and the tracking may work even if two devices far away from each other.

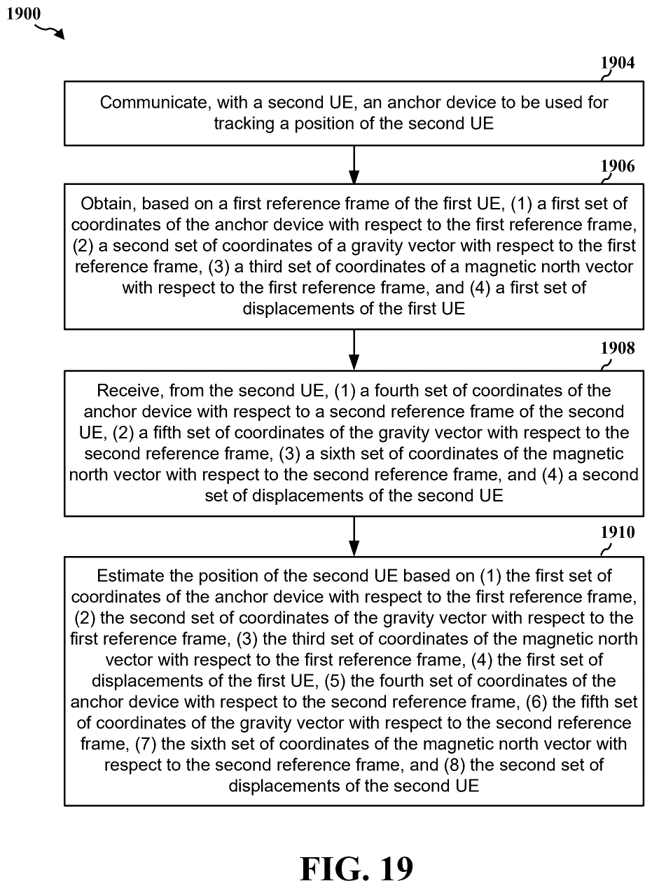

FIG. 19 is a flowchart 1900 of wireless communication at a user equipment (UE). The method may be performed by a UE (e.g., the UE 104, 404; the first device 502; the second device 504; the finder device 902; the target device 904; the apparatus 2104). The method may enable a first UE to track the location of the second UE (and vice versa) via a common anchor when they are not within a direct communication range of each other.

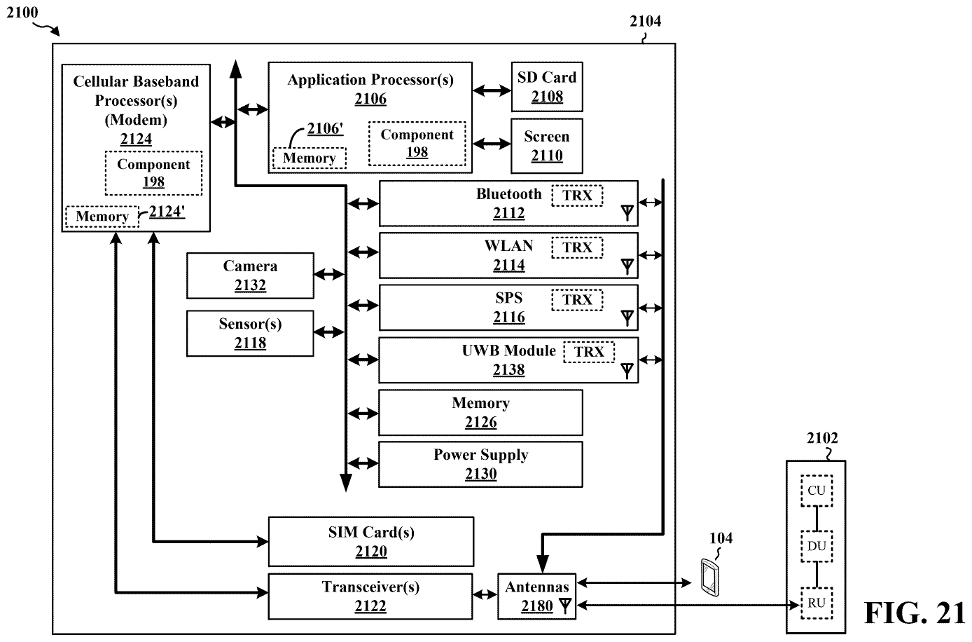

At 1904, the first UE may communicate, with a second UE, an anchor device to be used for tracking a position of the second UE, such as described in connection with FIGS. 9 to 16. For example, as discussed in connection with 1004 of FIG. 11, the finder device 902 and the target device 904 may exchange information with each other about nearby anchors, and the devices may agree to use a common anchor device that both can see (e.g., are able to communicate with), and also this common anchor device supports ranging (e.g., ToF ranging). The communication of the anchor device may be performed by, e.g., the tracking component 198, the transceiver(s) 2122, the Bluetooth module 2112, the WLAN module 2114, the UWB module 2138, the cellular baseband processor(s) 2124, and/or the application processor(s) 2106 of the apparatus 2104 in FIG. 21.

At 1906, the first UE may obtain, based on a first reference frame of the first UE, (1) a first set of coordinates of the anchor device with respect to the first reference frame, (2) a second set of coordinates of a gravity vector with respect to the first reference frame, (3) a third set of coordinates of a magnetic north vector with respect to the first reference frame, and (4) a first set of displacements of the first UE, such as described in connection with FIGS. 9 to 16. For example, as discussed in connection with 1008 of FIG. 13, based on that the gravity points for both devices are likely in the same physical direction, and that the magnetic north for both devices are also likely to point roughly in the same direction (but not exactly, so both devices may be configured to collect multiple samples and average them out), the devices may use the gravity point and the magnetic north to find a transformation between their reference frames (e.g., converting the reference frame or another device to its local reference frame). Thus, as shown at 1302, the finder device 902 may be configured to find the gravity unit vector (g) and the magnetic north unit vector (m) in its reference frame 908, such as using sensor(s) (e.g., an IMU, a magnetometer, etc.). The obtainment of the first set of coordinates of the anchor device with respect to the first reference frame, the second set of coordinates of a gravity vector with respect to the first reference frame, the third set of coordinates of a magnetic north vector with respect to the first reference frame, and the first set of displacements of the first UE may be performed by, e.g., the tracking component 198, the transceiver(s) 2122, the Bluetooth module 2112, the WLAN module 2114, the UWB module 2138, the cellular baseband processor(s) 2124, and/or the application processor(s) 2106 of the apparatus 2104 in FIG. 21.

At 1908, the first UE may receive, from the second UE, (1) a fourth set of coordinates of the anchor device with respect to a second reference frame of the second UE, (2) a fifth set of coordinates of the gravity vector with respect to the second reference frame, (3) a sixth set of coordinates of the magnetic north vector with respect to the second reference frame, and (4) a second set of displacements of the second UE, such as described in connection with FIGS. 9 to 16. For example, as discussed in connection with 1010 of FIG. 14, the finder device 902 and the target device 904 may exchange various information with each other. For example, as shown at 1402, one implementation is for the target device 904 to transmit the following information to the finder device 902 (measured in the local reference frame 910 of the target device 904): coordinates of the anchor device 906 (\vec{b}), gravity vector (\vec{h}), magnetic north vector (\vec{n}), and the (latest/current) position of the target device 904 (\vec{q_{M}}). The reception of the fourth set of coordinates of the anchor device with respect to a second reference frame of the second UE, the fifth set of coordinates of the gravity vector with respect to the second reference frame, the sixth set of coordinates of the magnetic north vector with respect to the second reference frame, and the second set of displacements of the second UE may be performed by, e.g., the tracking component 198, the transceiver(s) 2122, the Bluetooth module 2112, the WLAN module 2114, the UWB module 2138, the cellular baseband processor(s) 2124, and/or the application processor(s) 2106 of the apparatus 2104 in FIG. 21.

At 1910, the first UE may estimate the position of the second UE based on (1) the first set of coordinates of the anchor device with respect to the first reference frame, (2) the second set of coordinates of the gravity vector with respect to the first reference frame, (3) the third set of coordinates of the magnetic north vector with respect to the first reference frame, (4) the first set of displacements of the first UE, (5) the fourth set of coordinates of the anchor device with respect to the second reference frame, (6) the fifth set of coordinates of the gravity vector with respect to the second reference frame, (7) the sixth set of coordinates of the magnetic north vector with respect to the second reference frame, and (8) the second set of displacements of the second UE, such as described in connection with FIGS. 9 to 16. For example, as discussed in connection with 1012 of FIG. 15, after the information exchange, the devices may be able to locate each other. For example, the finder device 902 may use the following information to estimate the reference frame 910 of the target device 904: (1) coordinates of the anchor device 906 (in the reference frame 908 of the finder device 902 and the reference frame 910 of the target device 904), (2) gravity vector coordinates (in the reference frame 908 of the finder device 902 and the reference frame 910 of the target device 904), and (3) magnetic north vector coordinates (in the reference frame 908 of the finder device 902 and the reference frame 910 of the target device 904). After the reference frame 910 of the target device 904 is computed, the finder device 902 may use it to obtain the position of the target device 904. The estimation of the position of the second UE may be performed by, e.g., the tracking component 198, the transceiver(s) 2122, the Bluetooth module 2112, the WLAN module 2114, the UWB module 2138, the cellular baseband processor(s) 2124, and/or the application processor(s) 2106 of the apparatus 2104 in FIG. 21.

In one example, the first UE may determine that the second UE is not within a direct tracking range of the first UE, where the communication of the anchor device is based on the determination that the second UE is not within the direct tracking range of the first UE, such as described in connection with FIGS. 9 to 16. For example, as discussed in connection with 1102 of FIG. 11, both devices may be configured to first check whether they are within the reach of each other (e.g., with a direct communication range of each other). If the devices are within the reach of each other and are able to directly estimate their mutual distance, then they may perform the tracking/ranging without an anchor device, such as using the tracking mechanism described in connection with FIGS. 5 and 6. On the other hand, if (and assuming) the devices are not within the reach of each other (e.g., are not able to communicate directly with each other), both devices may be configured to search/scan for nearby anchors, and collect a list of candidate anchors. The communication that the second UE is not within a direct tracking range of the first UE may be performed by, e.g., the tracking component 198, the transceiver(s) 2122, the Bluetooth module 2112, the WLAN module 2114, the UWB module 2138, the cellular baseband processor(s) 2124, and/or the application processor(s) 2106 of the apparatus 2104 in FIG. 21.

In another example, the first UE may display, via a user interface (UI), the estimated position of the second UE, such as described in connection with FIGS. 9 to 16. For example, as discussed in connection with 1014 of FIG. 16, the finder device 902 may use information about the position of the target device 904 (in the local reference frame 908 of the finder device 902) to display directional information to the user of the finder device 902, such as via a UI. The display of the estimated position of the second UE may be performed by, e.g., the tracking component 198, the transceiver(s) 2122, the screen 2110, the cellular baseband processor(s) 2124, and/or the application processor(s) 2106 of the apparatus 2104 in FIG. 21.

In another example, the first UE may detect that the second UE is within a direct tracking range of the first UE, and estimate the position of the second UE based on direct tracking, such as described in connection with FIG. 18. For example, the devices may also be configured to (periodically) check whether they are within a direct communication range of each other. If the devices detect that they are within a direct communication range of each other, the devices may switch back to direct tracking/ranging mechanisms such as described in connection with FIGS. 5 and 6 instead of performing tracking/ranging via an anchor device. The detection that the second UE is within a direct tracking range of the first UE and/or the estimation of the position of the second UE may be performed by, e.g., the tracking component 198, the transceiver(s) 2122, the Bluetooth module 2112, the WLAN module 2114, the UWB module 2138, the cellular baseband processor(s) 2124, and/or the application processor(s) 2106 of the apparatus 2104 in FIG. 21.

In another example, the first UE may communicate, with the second UE, a request to initiate a tracking session for tracking the position of the second UE, where the communication of the anchor device is based on the communication of the request. In some implementations, to communicating, with the second UE, the request to initiate the tracking session, the first UE may be configured to transmit, to the second UE, the request to initiate the tracking session, or receive, from the second UE, the request to initiate the tracking session.

In another example, to communicate, with the second UE, the anchor device to be used for tracking the position of the second UE, the first UE may be configured to receive, from the second UE, a list of anchor devices that are within a direct tracking range of the second UE, select the anchor device from the list of anchor devices based on the anchor device also being within a direct tracking range of the first UE, and transmit, to the second UE, an indication of selection of the anchor device.

In another example, to communicate, with the second UE, the anchor device to be used for tracking the position of the second UE, the first UE may be configured to transmit, to the second UE, a list of anchor devices that are within a direct tracking range of the first UE, and receive, from the second UE, an indication to use the anchor device from the list of anchor devices for tracking the position of the second UE.

In another example, to estimate the position of the second UE based on (1) the first set of coordinates, (2) the second set of coordinates, (3) the third set of coordinates, (4) the first set of displacements of the first UE, (5) the fourth set of coordinates, (6) the fifth set of coordinates, (7) the sixth set of coordinates, and (8) the second set of displacements of the second UE, the first UE may be configured to compute the second reference frame of the second UE based on (1) the first set of coordinates, (2) the second set of coordinates, (3) the third set of coordinates, (4) the first set of displacements of the first UE, (5) the fourth set of coordinates, (6) the fifth set of coordinates, (7) the sixth set of coordinates, and (8) the second set of displacements of the second UE, and estimate the position of the second UE based on the computed second reference frame of the second UE.

In another example, the first reference frame is different from the second reference frame.

In another example, to obtain, based on the first reference frame of the first UE, (1) the first set of coordinates of the anchor device with respect to the first reference frame, the first UE may be configured to track the anchor device based on the first reference frame of the first UE using at least one of: UWB ranging, Wi-Fi® ranging, or BTCS.

In another example, to obtain, based on the first reference frame of the first UE, (4) the first set of displacements of the first UE, the first UE may be configured to track the first set of displacements of the first UE based on the first reference frame of the first UE using at least one of a camera or an IMU.

In another example, to obtain, based on the first reference frame of the first UE, (3) the third set of coordinates of the magnetic north vector with respect to the first reference frame, the first UE may be configured to estimate the magnetic north vector with respect to the first reference frame from multiple locations, and obtain the third set of coordinates of the magnetic north vector with respect to the first reference frame based on averaging multiple magnetic north vectors estimated from the multiple locations.

In another example, the first UE is a single-antenna UE or is configured to use one antenna in multiple antennas for tracking the position of the second UE.

In another example, the first UE may output an indication of the estimated position of the second UE. In some implementations, to output the indication of the estimated position of the second UE, the first UE may be configured to transmit the indication of the estimated position of the second UE, display the indication of the estimated position of the second UE via a display, or store the indication of the estimated position of the second UE.

In another example, the first UE may display, via a UI, the estimated position of the second UE. In some implementations, to display, via the UI, the estimated position of the second UE, the first UE may be configured to at least one of: display a direction of the second UE from the first UE, display a distance of the second UE from the first UE, or display an image or a description of the second UE.

In another example, the first UE may detect that the second UE is within a direct tracking range of the first UE, and estimate the position of the second UE based on direct tracking.

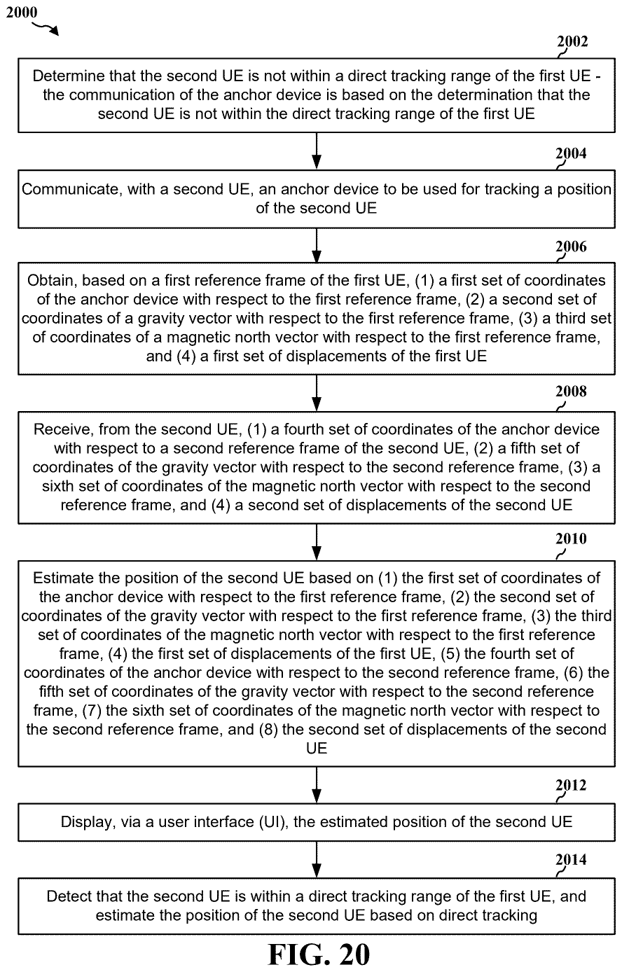

FIG. 20 is a flowchart 2000 of wireless communication at a user equipment (UE). The method may be performed by a UE (e.g., the UE 104, 404; the first device 502; the second device 504; the finder device 902; the target device 904; the apparatus 2104). The method may enable a first UE to track the location of the second UE (and vice versa) via a common anchor when they are not within a direct communication range of each other.

At 2004, the first UE may communicate, with a second UE, an anchor device to be used for tracking a position of the second UE, such as described in connection with FIGS. 9 to 16. For example, as discussed in connection with 1004 of FIG. 11, the finder device 902 and the target device 904 may exchange information with each other about nearby anchors, and the devices may agree to use a common anchor device that both can see (e.g., are able to communicate with), and also this common anchor device supports ranging (e.g., ToF ranging). The communication of the anchor device may be performed by, e.g., the tracking component 198, the transceiver(s) 2122, the Bluetooth module 2112, the WLAN module 2114, the UWB module 2138, the cellular baseband processor(s) 2124, and/or the application processor(s) 2106 of the apparatus 2104 in FIG. 21.

At 2006, the first UE may obtain, based on a first reference frame of the first UE, (1) a first set of coordinates of the anchor device with respect to the first reference frame, (2) a second set of coordinates of a gravity vector with respect to the first reference frame, (3) a third set of coordinates of a magnetic north vector with respect to the first reference frame, and (4) a first set of displacements of the first UE, such as described in connection with FIGS. 9 to 16. For example, as discussed in connection with 1008 of FIG. 13, based on that the gravity points for both devices are likely in the same physical direction, and that the magnetic north for both devices are also likely to point roughly in the same direction (but not exactly, so both devices may be configured to collect multiple samples and average them out), the devices may use the gravity point and the magnetic north to find a transformation between their reference frames (e.g., converting the reference frame or another device to its local reference frame). Thus, as shown at 1302, the finder device 902 may be configured to find the gravity unit vector (\vec{g}) and the magnetic north unit vector (\vec{m}) in its reference frame 908, such as using sensor(s) (e.g., an IMU, a magnetometer, etc.). The obtainment of the first set of coordinates of the anchor device with respect to the first reference frame, the second set of coordinates of a gravity vector with respect to the first reference frame, the third set of coordinates of a magnetic north vector with respect to the first reference frame, and the first set of displacements of the first UE may be performed by, e.g., the tracking component 198, the transceiver(s) 2122, the Bluetooth module 2112, the WLAN module 2114, the UWB module 2138, the cellular baseband processor(s) 2124, and/or the application processor(s) 2106 of the apparatus 2104 in FIG. 21.

At 2008, the first UE may receive, from the second UE, (1) a fourth set of coordinates of the anchor device with respect to a second reference frame of the second UE, (2) a fifth set of coordinates of the gravity vector with respect to the second reference frame, (3) a sixth set of coordinates of the magnetic north vector with respect to the second reference frame, and (4) a second set of displacements of the second UE, such as described in connection with FIGS. 9 to 16. For example, as discussed in connection with 1010 of FIG. 14, the finder device 902 and the target device 904 may exchange various information with each other. For example, as shown at 1402, one implementation is for the target device 904 to transmit the following information to the finder device 902 (measured in the local reference frame 910 of the target device 904): coordinates of the anchor device 906 (b), gravity vector (h), magnetic north vector (n), and the (latest/current) position of the target device 904 (q_{M}). The reception of the fourth set of coordinates of the anchor device with respect to a second reference frame of the second UE, the fifth set of coordinates of the gravity vector with respect to the second reference frame, the sixth set of coordinates of the magnetic north vector with respect to the second reference frame, and the second set of displacements of the second UE may be performed by, e.g., the tracking component 198, the transceiver(s) 2122, the Bluetooth module 2112, the WLAN module 2114, the UWB module 2138, the cellular baseband processor(s) 2124, and/or the application processor(s) 2106 of the apparatus 2104 in FIG. 21.

At 2010, the first UE may estimate the position of the second UE based on (1) the first set of coordinates of the anchor device with respect to the first reference frame, (2) the second set of coordinates of the gravity vector with respect to the first reference frame, (3) the third set of coordinates of the magnetic north vector with respect to the first reference frame, (4) the first set of displacements of the first UE, (5) the fourth set of coordinates of the anchor device with respect to the second reference frame, (6) the fifth set of coordinates of the gravity vector with respect to the second reference frame, (7) the sixth set of coordinates of the magnetic north vector with respect to the second reference frame, and (8) the second set of displacements of the second UE, such as described in connection with FIGS. 9 to 16. For example, as discussed in connection with 1012 of FIG. 15, after the information exchange, the devices may be able to locate each other. For example, the finder device 902 may use the following information to estimate the reference frame 910 of the target device 904: (1) coordinates of the anchor device 906 (in the reference frame 908 of the finder device 902 and the reference frame 910 of the target device 904), (2) gravity vector coordinates (in the reference frame 908 of the finder device 902 and the reference frame 910 of the target device 904), and (3) magnetic north vector coordinates (in the reference frame 908 of the finder device 902 and the reference frame 910 of the target device 904). After the reference frame 910 of the target device 904 is computed, the finder device 902 may use it to obtain the position of the target device 904. The estimation of the position of the second UE may be performed by, e.g., the tracking component 198, the transceiver(s) 2122, the Bluetooth module 2112, the WLAN module 2114, the UWB module 2138, the cellular baseband processor(s) 2124, and/or the application processor(s) 2106 of the apparatus 2104 in FIG. 21.

In one example, as shown at 2002, the first UE may determine that the second UE is not within a direct tracking range of the first UE, where the communication of the anchor device is based on the determination that the second UE is not within the direct tracking range of the first UE, such as described in connection with FIGS. 9 to 16. For example, as discussed in connection with 1102 of FIG. 11, both devices may be configured to first check whether they are within the reach of each other (e.g., with a direct communication range of each other). If the devices are within the reach of each other and are able to directly estimate their mutual distance, then they may perform the tracking/ranging without an anchor device, such as using the tracking mechanism described in connection with FIGS. 5 and 6. On the other hand, if (and assuming) the devices are not within the reach of each other (e.g., are not able to communicate directly with each other), both devices may be configured to search/scan for nearby anchors, and collect a list of candidate anchors. The communication that the second UE is not within a direct tracking range of the first UE may be performed by, e.g., the tracking component 198, the transceiver(s) 2122, the Bluetooth module 2112, the WLAN module 2114, the UWB module 2138, the cellular baseband processor(s) 2124, and/or the application processor(s) 2106 of the apparatus 2104 in FIG. 21.

In another example, as shown at 2012, the first UE may display, via a UI, the estimated position of the second UE, such as described in connection with FIGS. 9 to 16. For example, as discussed in connection with 1014 of FIG. 16, the finder device 902 may use information about the position of the target device 904 (in the local reference frame 908 of the finder device 902) to display directional information to the user of the finder device 902, such as via a UI. The display of the estimated position of the second UE may be performed by, e.g., the tracking component 198, the transceiver(s) 2122, the screen 2110, the cellular baseband processor(s) 2124, and/or the application processor(s) 2106 of the apparatus 2104 in FIG. 21.

In another example, as shown at 2014, the first UE may detect that the second UE is within a direct tracking range of the first UE, and estimate the position of the second UE based on direct tracking, such as described in connection with FIG. 18. For example, the devices may also be configured to (periodically) check whether they are within a direct communication range of each other. If the devices detect that they are within a direct communication range of each other, the devices may switch back to direct tracking/ranging mechanisms such as described in connection with FIGS. 5 and 6 instead of performing tracking/ranging via an anchor device. The detection that the second UE is within a direct tracking range of the first UE and/or the estimation of the position of the second UE may be performed by, e.g., the tracking component 198, the transceiver(s) 2122, the Bluetooth module 2112, the WLAN module 2114, the UWB module 2138, the cellular baseband processor(s) 2124, and/or the application processor(s) 2106 of the apparatus 2104 in FIG. 21.

In another example, the first UE may communicate, with the second UE, a request to initiate a tracking session for tracking the position of the second UE, where the communication of the anchor device is based on the communication of the request. In some implementations, to communicating, with the second UE, the request to initiate the tracking session, the first UE may be configured to transmit, to the second UE, the request to initiate the tracking session, or receive, from the second UE, the request to initiate the tracking session.

In another example, to communicate, with the second UE, the anchor device to be used for tracking the position of the second UE, the first UE may be configured to receive, from the second UE, a list of anchor devices that are within a direct tracking range of the second UE, select the anchor device from the list of anchor devices based on the anchor device also being within a direct tracking range of the first UE, and transmit, to the second UE, an indication of selection of the anchor device.

In another example, to communicate, with the second UE, the anchor device to be used for tracking the position of the second UE, the first UE may be configured to transmit, to the second UE, a list of anchor devices that are within a direct tracking range of the first UE, and receive, from the second UE, an indication to use the anchor device from the list of anchor devices for tracking the position of the second UE.

In another example, to estimate the position of the second UE based on (1) the first set of coordinates, (2) the second set of coordinates, (3) the third set of coordinates, (4) the first set of displacements of the first UE, (5) the fourth set of coordinates, (6) the fifth set of coordinates, (7) the sixth set of coordinates, and (8) the second set of displacements of the second UE, the first UE may be configured to compute the second reference frame of the second UE based on (1) the first set of coordinates, (2) the second set of coordinates, (3) the third set of coordinates, (4) the first set of displacements of the first UE, (5) the fourth set of coordinates, (6) the fifth set of coordinates, (7) the sixth set of coordinates, and (8) the second set of displacements of the second UE, and estimate the position of the second UE based on the computed second reference frame of the second UE.

In another example, the first reference frame is different from the second reference frame.

In another example, to obtain, based on the first reference frame of the first UE, (1) the first set of coordinates of the anchor device with respect to the first reference frame, the first UE may be configured to track the anchor device based on the first reference frame of the first UE using at least one of: UWB ranging, Wi-Fi® ranging, or BTCS.

In another example, to obtain, based on the first reference frame of the first UE, (4) the first set of displacements of the first UE, the first UE may be configured to track the first set of displacements of the first UE based on the first reference frame of the first UE using at least one of a camera or an IMU.

In another example, to obtain, based on the first reference frame of the first UE, (3) the third set of coordinates of the magnetic north vector with respect to the first reference frame, the first UE may be configured to estimate the magnetic north vector with respect to the first reference frame from multiple locations, and obtain the third set of coordinates of the magnetic north vector with respect to the first reference frame based on averaging multiple magnetic north vectors estimated from the multiple locations.

In another example, the first UE is a single-antenna UE or is configured to use one antenna in multiple antennas for tracking the position of the second UE.

In another example, the first UE may output an indication of the estimated position of the second UE. In some implementations, to output the indication of the estimated position of the second UE, the first UE may be configured to transmit the indication of the estimated position of the second UE, display the indication of the estimated position of the second UE via a display, or store the indication of the estimated position of the second UE.

In another example, the first UE may display, via a UI, the estimated position of the second UE. In some implementations, to display, via the UI, the estimated position of the second UE, the first UE may be configured to at least one of: display a direction of the second UE from the first UE, display a distance of the second UE from the first UE, or display an image or a description of the second UE.

In another example, the first UE may detect that the second UE is within a direct tracking range of the first UE, and estimate the position of the second UE based on direct tracking.

FIG. 21 is a diagram 2100 illustrating an example of a hardware implementation for an apparatus 2104. The apparatus 2104 may be a UE (e.g., a first UE), a component of a UE, or may implement UE functionality. In some aspects, the apparatus 2104 may include at least one cellular baseband processor 2124 (also referred to as a modem) coupled to one or more transceivers 2122 (e.g., cellular RF transceiver). The cellular baseband processor(s) 2124 may include at least one on-chip memory 2124′. In some aspects, the apparatus 2104 may further include one or more subscriber identity modules (SIM) cards 2120 and at least one application processor 2106 coupled to a secure digital (SD) card 2108 and a screen 2110. The application processor(s) 2106 may include on-chip memory 2106′. In some aspects, the apparatus 2104 may further include a Bluetooth module 2112, a WLAN module 2114, an ultrawide band (UWB) module 2138 (e.g., a UWB transceiver), an SPS module 2116 (e.g., GNSS module), one or more sensors 2118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2126, a power supply 2130, and/or a camera 2132. The Bluetooth module 2112, the UWB module 2138, the WLAN module 2114, and the SPS module 2116 may include an on-chip transceiver (TRX) (or in some cases, just a receiver (RX)). The Bluetooth module 2112, the WLAN module 2114, and the SPS module 2116 may include their own dedicated antennas and/or utilize the antennas 2180 for communication. The cellular baseband processor(s) 2124 communicates through the transceiver(s) 2122 via one or more antennas 2180 with the UE 104 and/or with an RU associated with a network entity 2102. The cellular baseband processor(s) 2124 and the application processor(s) 2106 may each include a computer-readable medium/memory 2124′, 2106′, respectively. The additional memory modules 2126 may also be considered a computer-readable medium/memory. Each computer-readable medium/memory 2124′, 2106′, 2126 may be non-transitory. The cellular baseband processor(s) 2124 and the application processor(s) 2106 are each responsible for general processing, including the execution of software stored on the computer-readable medium/memory. The software, when executed by the cellular baseband processor(s) 2124/application processor(s) 2106, causes the cellular baseband processor(s) 2124/application processor(s) 2106 to perform the various functions described supra. The cellular baseband processor(s) 2124 and the application processor(s) 2106 arc configured to perform the various functions described supra based at least in part of the information stored in the memory. That is, the cellular baseband processor(s) 2124 and the application processor(s) 2106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 2124/application processor(s) 2106 when executing software. The cellular baseband processor(s) 2124/application processor(s) 2106 may be a component of the UE 350 and may include the at least one memory 360 and/or at least one of the TX processor 368, the RX processor 356, and the controller/processor 359. In one configuration, the apparatus 2104 may be at least one processor chip (modem and/or application) and include just the cellular baseband processor(s) 2124 and/or the application processor(s) 2106, and in another configuration, the apparatus 2104 may be the entire UE (e.g., see UE 350 of FIG. 3) and include the additional modules of the apparatus 2104.

As discussed supra, the tracking component 198 may be configured to communicate, with a second UE, an anchor device to be used for tracking a position of the second UE. The tracking component 198 may also be configured to obtain, based on a first reference frame of the first UE, (1) a first set of coordinates of the anchor device with respect to the first reference frame, (2) a second set of coordinates of a gravity vector with respect to the first reference frame, (3) a third set of coordinates of a magnetic north vector with respect to the first reference frame, and (4) a first set of displacements of the first UE. The tracking component 198 may also be configured to receive, from the second UE, (1) a fourth set of coordinates of the anchor device with respect to a second reference frame of the second UE, (2) a fifth set of coordinates of the gravity vector with respect to the second reference frame, (3) a sixth set of coordinates of the magnetic north vector with respect to the second reference frame, and (4) a second set of displacements of the second UE. The tracking component 198 may also be configured to estimate the position of the second UE based on (1) the first set of coordinates of the anchor device with respect to the first reference frame, (2) the second set of coordinates of the gravity vector with respect to the first reference frame, (3) the third set of coordinates of the magnetic north vector with respect to the first reference frame, (4) the first set of displacements of the first UE, (5) the fourth set of coordinates of the anchor device with respect to the second reference frame, (6) the fifth set of coordinates of the gravity vector with respect to the second reference frame, (7) the sixth set of coordinates of the magnetic north vector with respect to the second reference frame, and (8) the second set of displacements of the second UE. The tracking component 198 may be within the cellular baseband processor(s) 2124, the application processor(s) 2106, or both the cellular baseband processor(s) 2124 and the application processor(s) 2106. The tracking component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2104 may include a variety of components configured for various functions. In one configuration, the apparatus 2104, and in particular the cellular baseband processor(s) 2124 and/or the application processor(s) 2106, may include means for communicating, with a second UE, an anchor device to be used for tracking a position of the second UE. The apparatus 2104 may further include means for obtaining, based on a first reference frame of the first UE, (1) a first set of coordinates of the anchor device with respect to the first reference frame, (2) a second set of coordinates of a gravity vector with respect to the first reference frame, (3) a third set of coordinates of a magnetic north vector with respect to the first reference frame, and (4) a first set of displacements of the first UE. The apparatus 2104 may further include means for receiving, from the second UE, (1) a fourth set of coordinates of the anchor device with respect to a second reference frame of the second UE, (2) a fifth set of coordinates of the gravity vector with respect to the second reference frame, (3) a sixth set of coordinates of the magnetic north vector with respect to the second reference frame, and (4) a second set of displacements of the second UE. The apparatus 2104 may further include means for estimating the position of the second UE based on (1) the first set of coordinates of the anchor device with respect to the first reference frame, (2) the second set of coordinates of the gravity vector with respect to the first reference frame, (3) the third set of coordinates of the magnetic north vector with respect to the first reference frame, (4) the first set of displacements of the first UE, (5) the fourth set of coordinates of the anchor device with respect to the second reference frame, (6) the fifth set of coordinates of the gravity vector with respect to the second reference frame, (7) the sixth set of coordinates of the magnetic north vector with respect to the second reference frame, and (8) the second set of displacements of the second UE.

In one configuration, the apparatus 2104 may further include means for determining that the second UE is not within a direct tracking range of the first UE, where the communication of the anchor device is based on the determination that the second UE is not within the direct tracking range of the first UE.

In another configuration, the apparatus 2104 may further include means for displaying, via a UI, the estimated position of the second UE.

In another configuration, the apparatus 2104 may further include means for detecting that the second UE is within a direct tracking range of the first UE, and means for estimating the position of the second UE based on direct tracking.

In another configuration, the apparatus 2104 may further include means for communicating, with the second UE, a request to initiate a tracking session for tracking the position of the second UE, where the communication of the anchor device is based on the communication of the request. In some implementations, the means for communicating, with the second UE, the request to initiate the tracking session may include configuring the apparatus 2104 to transmit, to the second UE, the request to initiate the tracking session, or receive, from the second UE, the request to initiate the tracking session.

In another configuration, the means for communicating, with the second UE, the anchor device to be used for tracking the position of the second UE may include configuring the apparatus 2104 to receive, from the second UE, a list of anchor devices that are within a direct tracking range of the second UE, select the anchor device from the list of anchor devices based on the anchor device also being within a direct tracking range of the first UE, and transmit, to the second UE, an indication of selection of the anchor device.

In another configuration, the means for communicating, with the second UE, the anchor device to be used for tracking the position of the second UE may include configuring the apparatus 2104 to transmit, to the second UE, a list of anchor devices that are within a direct tracking range of the first UE, and receive, from the second UE, an indication to use the anchor device from the list of anchor devices for tracking the position of the second UE.

In another configuration, the means for estimating the position of the second UE based on (1) the first set of coordinates, (2) the second set of coordinates, (3) the third set of coordinates, (4) the first set of displacements of the first UE, (5) the fourth set of coordinates, (6) the fifth set of coordinates, (7) the sixth set of coordinates, and (8) the second set of displacements of the second UE may include configuring the apparatus 2104 to compute the second reference frame of the second UE based on (1) the first set of coordinates, (2) the second set of coordinates, (3) the third set of coordinates, (4) the first set of displacements of the first UE, (5) the fourth set of coordinates, (6) the fifth set of coordinates, (7) the sixth set of coordinates, and (8) the second set of displacements of the second UE, and estimate the position of the second UE based on the computed second reference frame of the second UE.

In another configuration, the first reference frame is different from the second reference frame.

In another configuration, the means for obtaining, based on the first reference frame of the first UE, (1) the first set of coordinates of the anchor device with respect to the first reference frame may include configuring the apparatus 2104 to track the anchor device based on the first reference frame of the first UE using at least one of: UWB ranging, Wi-Fi® ranging, or BTCS.

In another configuration, the means for obtaining, based on the first reference frame of the first UE, (4) the first set of displacements of the apparatus 2104 may further include means for configuring the apparatus 2104 to track the first set of displacements of the first UE based on the first reference frame of the first UE using at least one of a camera or an IMU.

In another configuration, the means for obtaining, based on the first reference frame of the first UE, (3) the third set of coordinates of the magnetic north vector with respect to the first reference frame may include configuring the apparatus 2104 to estimate the magnetic north vector with respect to the first reference frame from multiple locations, and obtain the third set of coordinates of the magnetic north vector with respect to the first reference frame based on averaging multiple magnetic north vectors estimated from the multiple locations.

In another configuration, the first UE is a single-antenna UE or is configured to use one antenna in multiple antennas for tracking the position of the second UE.

In another configuration, the apparatus 2104 may further include means for outputting an indication of the estimated position of the second UE. In some implementations, the means for outputting the indication of the estimated position of the second UE may include configuring the apparatus 2104 to transmit the indication of the estimated position of the second UE, display the indication of the estimated position of the second UE via a display, or store the indication of the estimated position of the second UE.

In another configuration, the apparatus 2104 may further include means for displaying, via a UI, the estimated position of the second UE. In some implementations, the means for displaying, via the UI, the estimated position of the second UE may include configuring the apparatus 2104 to at least one of: display a direction of the second UE from the first UE, display a distance of the second UE from the first UE, or display an image or a description of the second UE.

In another configuration, the apparatus 2104 may further include means for detecting that the second UE is within a direct tracking range of the first UE, and estimate the position of the second UE based on direct tracking.

The means may be the tracking component 198 of the apparatus 2104 configured to perform the functions recited by the means. As described supra, the apparatus 2104 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first user equipment (UE), comprising: communicating, with a second UE, an anchor device to be used for tracking a position of the second UE; obtaining, based on a first reference frame of the first UE, (1) a first set of coordinates of the anchor device with respect to the first reference frame, (2) a second set of coordinates of a gravity vector with respect to the first reference frame, (3) a third set of coordinates of a magnetic north vector with respect to the first reference frame, and (4) a first set of displacements of the first UE; receiving, from the second UE, (1) a fourth set of coordinates of the anchor device with respect to a second reference frame of the second UE, (2) a fifth set of coordinates of the gravity vector with respect to the second reference frame, (3) a sixth set of coordinates of the magnetic north vector with respect to the second reference frame, and (4) a second set of displacements of the second UE; and estimating the position of the second UE based on (1) the first set of coordinates of the anchor device with respect to the first reference frame, (2) the second set of coordinates of the gravity vector with respect to the first reference frame, (3) the third set of coordinates of the magnetic north vector with respect to the first reference frame, (4) the first set of displacements of the first UE, (5) the fourth set of coordinates of the anchor device with respect to the second reference frame, (6) the fifth set of coordinates of the gravity vector with respect to the second reference frame, (7) the sixth set of coordinates of the magnetic north vector with respect to the second reference frame, and (8) the second set of displacements of the second UE.

Aspect 2 is the method of aspect 1, further comprising: determining that the second UE is not within a direct tracking range of the first UE, wherein the communication of the anchor device is based on the determination that the second UE is not within the direct tracking range of the first UE.

Aspect 3 is the method of aspect 1 or aspect 2, further comprising: communicating, with the second UE, a request to initiate a tracking session for tracking the position of the second UE, wherein the communication of the anchor device is based on the communication of the request.

Aspect 4 is the method of any of aspects 1 to 3, wherein communicating, with the second UE, the request to initiate the tracking session comprises: transmitting, to the second UE, the request to initiate the tracking session, or receiving, from the second UE, the request to initiate the tracking session.

Aspect 5 is the method of any of aspects 1 to 4, wherein communicating, with the second UE, the anchor device to be used for tracking the position of the second UE comprises: receiving, from the second UE, a list of anchor devices that are within a direct tracking range of the second UE; selecting the anchor device from the list of anchor devices based on the anchor device also being within a direct tracking range of the first UE; and transmitting, to the second UE, an indication of selection of the anchor device.

Aspect 6 is the method of any of aspects 1 to 5, wherein communicating, with the second UE, the anchor device to be used for tracking the position of the second UE comprises: transmitting, to the second UE, a list of anchor devices that are within a direct tracking range of the first UE; and receiving, from the second UE, an indication to use the anchor device from the list of anchor devices for tracking the position of the second UE.

Aspect 7 is the method of any of aspects 1 to 6, wherein estimating the position of the second UE based on (1) the first set of coordinates, (2) the second set of coordinates, (3) the third set of coordinates, (4) the first set of displacements of the first UE, (5) the fourth set of coordinates, (6) the fifth set of coordinates, (7) the sixth set of coordinates, and (8) the second set of displacements of the second UE comprises: computing the second reference frame of the second UE based on (1) the first set of coordinates, (2) the second set of coordinates, (3) the third set of coordinates, (4) the first set of displacements of the first UE, (5) the fourth set of coordinates, (6) the fifth set of coordinates, (7) the sixth set of coordinates, and (8) the second set of displacements of the second UE; and estimating the position of the second UE based on the computed second reference frame of the second UE.

Aspect 8 is the method of any of aspects 1 to 7, wherein the first reference frame is different from the second reference frame.

Aspect 9 is the method of any of aspects 1 to 8, wherein obtaining, based on the first reference frame of the first UE, (1) the first set of coordinates of the anchor device with respect to the first reference frame comprises: tracking the anchor device based on the first reference frame of the first UE using at least one of: ultrawide band (UWB) ranging, Wi-Fi® ranging, or Bluetooth® channel sounding (BTCS).

Aspect 10 is the method of any of aspects 1 to 9, wherein obtaining, based on the first reference frame of the first UE, (4) the first set of displacements of the first UE comprises: tracking the first set of displacements of the first UE based on the first reference frame of the first UE using at least one of a camera or an inertial measurement unit (IMU).

Aspect 11 is the method of any of aspects 1 to 10, wherein obtaining, based on the first reference frame of the first UE, (3) the third set of coordinates of the magnetic north vector with respect to the first reference frame comprises: estimating the magnetic north vector with respect to the first reference frame from multiple locations; and obtaining the third set of coordinates of the magnetic north vector with respect to the first reference frame based on averaging multiple magnetic north vectors estimated from the multiple locations.

Aspect 12 is the method of any of aspects 1 to 11, wherein the first UE is a single-antenna UE or is configured to use one antenna in multiple antennas for tracking the position of the second UE.

Aspect 13 is the method of any of aspects 1 to 12, further comprising: outputting an indication of the estimated position of the second UE.

Aspect 14 is the method of any of aspects 1 to 13, wherein outputting the indication of the estimated position of the second UE comprises: transmitting the indication of the estimated position of the second UE; displaying the indication of the estimated position of the second UE via a display, or storing the indication of the estimated position of the second UE.

Aspect 15 is the method of any of aspects 1 to 14, further comprising: displaying, via a user interface (UI), the estimated position of the second UE.

Aspect 16 is the method of any of aspects 1 to 15, wherein displaying, via the UI, the estimated position of the second UE includes at least one of: displaying a direction of the second UE from the first UE, displaying a distance of the second UE from the first UE, or displaying an image or a description of the second UE.

Aspect 17 is the method of any of aspects 1 to 16, further comprising: detecting that the second UE is within a direct tracking range of the first UE; and estimating the position of the second UE based on direct tracking.

Aspect 18 is an apparatus for wireless communication at a first user equipment (UE), including: at least one memory; and at least one processor coupled to the at least one memory and, based at least in part on stored information that is stored in the at least one memory, the at least one processor, individually or in any combination, is configured to implement any of aspects 1 to 17.

Aspect 19 is the apparatus of aspect 18, further including at least one transceiver coupled to the at least one processor.

Aspect 20 is an apparatus for wireless communication at a first user equipment (UE) including means for implementing any of aspects 1 to 17.

Aspect 21 is a computer-readable medium (e.g., a non-transitory computer-readable medium) storing computer executable code, where the code when executed by a processor causes the processor to implement any of aspects 1 to 17.

What is claimed is:

1. An apparatus for wireless communication at a first user equipment (UE), comprising:
at least one memory; and
at least one processor coupled to the at least one memory, the at least one processor, individually or in any combination, is configured to:
communicate, with a second UE, an anchor device to be used for tracking a position of the second UE;
obtain, based on a first reference frame of the first UE, (1) a first set of coordinates of the anchor device with respect to the first reference frame, (2) a second set of coordinates of a gravity vector with respect to the first reference frame, (3) a third set of coordinates of a magnetic north vector with respect to the first reference frame, and (4) a first set of displacements of the first UE;
receive, from the second UE, (1) a fourth set of coordinates of the anchor device with respect to a second reference frame of the second UE, (2) a fifth set of coordinates of the gravity vector with respect to the second reference frame, (3) a sixth set of coordinates of the magnetic north vector with respect to the second reference frame, and (4) a second set of displacements of the second UE; and
estimate the position of the second UE based on (1) the first set of coordinates of the anchor device with respect to the first reference frame, (2) the second set of coordinates of the gravity vector with respect to the first reference frame, (3) the third set of coordinates of the magnetic north vector with respect to the first reference frame, (4) the first set of displacements of the first UE, (5) the fourth set of coordinates of the anchor device with respect to the second reference frame, (6) the fifth set of coordinates of the gravity vector with respect to the second reference frame, (7) the sixth set of coordinates of the magnetic north vector with respect to the second reference frame, and (8) the second set of displacements of the second UE.

2. The apparatus of claim 1, wherein the at least one processor, individually or in any combination, is further configured to:
determine that the second UE is not within a direct tracking range of the first UE, wherein the communication of the anchor device is based on the determination that the second UE is not within the direct tracking range of the first UE.

3. The apparatus of claim 1, wherein the at least one processor, individually or in any combination, is further configured to:
communicate, with the second UE, a request to initiate a tracking session for tracking the position of the second UE, wherein the communication of the anchor device is based on the communication of the request.

4. The apparatus of claim 3, wherein to communicate, with the second UE, the request to initiate the tracking session, the at least one processor, individually or in any combination, is configured to:
transmit, to the second UE, the request to initiate the tracking session, or receive, from the second UE, the request to initiate the tracking session.

5. The apparatus of claim 1, wherein to communicate, with the second UE, the anchor device to be used for tracking the position of the second UE, the at least one processor, individually or in any combination, is configured to:
receive, from the second UE, a list of anchor devices that are within a direct tracking range of the second UE;
select the anchor device from the list of anchor devices based on the anchor device also being within a direct tracking range of the first UE; and
transmit, to the second UE, an indication of selection of the anchor device.

6. The apparatus of claim 1, wherein to communicate, with the second UE, the anchor device to be used for tracking the position of the second UE, the at least one processor, individually or in any combination, is configured to:
transmit, to the second UE, a list of anchor devices that are within a direct tracking range of the first UE; and
receive, from the second UE, an indication to use the anchor device from the list of anchor devices for tracking the position of the second UE.

7. The apparatus of claim 1, wherein to estimate the position of the second UE based on (1) the first set of coordinates, (2) the second set of coordinates, (3) the third set of coordinates, (4) the first set of displacements of the first UE, (5) the fourth set of coordinates, (6) the fifth set of coordinates, (7) the sixth set of coordinates, and (8) the second set of displacements of the second UE, the at least one processor, individually or in any combination, is configured to:
compute the second reference frame of the second UE based on (1) the first set of coordinates, (2) the second set of coordinates, (3) the third set of coordinates, (4) the first set of displacements of the first UE, (5) the fourth set of coordinates, (6) the fifth set of coordinates, (7) the sixth set of coordinates, and (8) the second set of displacements of the second UE; and
estimate the position of the second UE based on the computed second reference frame of the second UE.

8. The apparatus of claim 1, wherein the first reference frame is different from the second reference frame.

9. The apparatus of claim 1, wherein to obtain, based on the first reference frame of the first UE, (1) the first set of coordinates of the anchor device with respect to the first reference frame, the at least one processor, individually or in any combination, is configured to:
track the anchor device based on the first reference frame of the first UE using at least one of: ultrawide band (UWB) ranging, Wi-Fi® ranging, or Bluetooth® channel sounding (BTCS).

10. The apparatus of claim 1, wherein to obtain, based on the first reference frame of the first UE, (4) the first set of displacements of the first UE, the at least one processor, individually or in any combination, is configured to:
track the first set of displacements of the first UE based on the first reference frame of the first UE using at least one of a camera or an inertial measurement unit (IMU).

11. The apparatus of claim 1, wherein to obtain, based on the first reference frame of the first UE, (3) the third set of coordinates of the magnetic north vector with respect to the first reference frame, the at least one processor, individually or in any combination, is configured to:
estimate the magnetic north vector with respect to the first reference frame from multiple locations; and
obtain the third set of coordinates of the magnetic north vector with respect to the first reference frame based on averaging multiple magnetic north vectors estimated from the multiple locations.

12. The apparatus of claim 1, wherein the first UE is a single-antenna UE or is configured to use one antenna in multiple antennas for tracking the position of the second UE.

13. The apparatus of claim 1, wherein the at least one processor, individually or in any combination, is further configured to:
output an indication of the estimated position of the second UE.

14. The apparatus of claim 13, wherein to output the indication of the estimated position of the second UE, the at least one processor, individually or in any combination, is configured to:
transmit the indication of the estimated position of the second UE;
display the indication of the estimated position of the second UE via a display, or store the indication of the estimated position of the second UE.

15. The apparatus of claim 1, wherein the at least one processor, individually or in any combination, is further configured to:
display, via a user interface (UI), the estimated position of the second UE.

16. The apparatus of claim 15, wherein to display, via the UI, the estimated position of the second UE, the at least one processor, individually or in any combination, is configured to at least one of:
display a direction of the second UE from the first UE,
display a distance of the second UE from the first UE, or
display an image or a description of the second UE.

17. The apparatus of claim 1, wherein the at least one processor, individually or in any combination, is further configured to:
detect that the second UE is within a direct tracking range of the first UE; and
estimate the position of the second UE based on direct tracking.

18. A method of wireless communication at a first user equipment (UE), comprising:
communicating, with a second UE, an anchor device to be used for tracking a position of the second UE;
obtaining, based on a first reference frame of the first UE, (1) a first set of coordinates of the anchor device with respect to the first reference frame, (2) a second set of coordinates of a gravity vector with respect to the first reference frame, (3) a third set of coordinates of a magnetic north vector with respect to the first reference frame, and (4) a first set of displacements of the first UE;
receiving, from the second UE, (1) a fourth set of coordinates of the anchor device with respect to a second reference frame of the second UE, (2) a fifth set of coordinates of the gravity vector with respect to the second reference frame, (3) a sixth set of coordinates of the magnetic north vector with respect to the second reference frame, and (4) a second set of displacements of the second UE; and
estimating the position of the second UE based on (1) the first set of coordinates of the anchor device with respect to the first reference frame, (2) the second set of coordinates of the gravity vector with respect to the first reference frame, (3) the third set of coordinates of the magnetic north vector with respect to the first reference frame, (4) the first set of displacements of the first UE, (5) the fourth set of coordinates of the anchor device with respect to the second reference frame, (6) the fifth set of coordinates of the gravity vector with respect to the second reference frame, (7) the sixth set of coordinates of the magnetic north vector with respect to the second reference frame, and (8) the second set of displacements of the second UE.

19. The method of claim 18, further comprising:
determining that the second UE is not within a direct tracking range of the first UE, wherein the communication of the anchor device is based on the determination that the second UE is not within the direct tracking range of the first UE.

20. A computer-readable medium storing computer executable code at a first user equipment (UE), the code when executed by at least one processor causes the at least one processor to:
communicate, with a second UE, an anchor device to be used for tracking a position of the second UE;
obtain, based on a first reference frame of the first UE, (1) a first set of coordinates of the anchor device with respect to the first reference frame, (2) a second set of coordinates of a gravity vector with respect to the first reference frame, (3) a third set of coordinates of a magnetic north vector with respect to the first reference frame, and (4) a first set of displacements of the first UE;
receive, from the second UE, (1) a fourth set of coordinates of the anchor device with respect to a second reference frame of the second UE, (2) a fifth set of coordinates of the gravity vector with respect to the second reference frame, (3) a sixth set of coordinates of the magnetic north vector with respect to the second reference frame, and (4) a second set of displacements of the second UE; and
estimate the position of the second UE based on (1) the first set of coordinates of the anchor device with respect to the first reference frame, (2) the second set of coordinates of the gravity vector with respect to the first reference frame, (3) the third set of coordinates of the magnetic north vector with respect to the first reference frame, (4) the first set of displacements of the first UE, (5) the fourth set of coordinates of the anchor device with respect to the second reference frame, (6) the fifth set of coordinates of the gravity vector with respect to the second reference frame, (7) the sixth set of coordinates of the magnetic north vector with respect to the second reference frame, and (8) the second set of displacements of the second UE.
